(19) United States
(12) Patent Application Publication
(10) Pub. No.: US 2024/0412337 A1
(43) Pub. Date: Dec. 12, 2024

(54) METHOD AND ELECTRONIC DEVICE FOR PERFORMING OBJECT REMOVAL PROCESSING

(71) Applicant: SAMSUNG ELECTRONICS CO., LTD., Suwon-si (KR)

(72) Inventors: Mengmeng BAI, Beijing (CN); Huiling Chang, Beijing (CN); Zhuoxin Gan, Beijing (CN); Jaekeun Na, Suwon-si (KR); Changwei Wang, Beijing (CN); Li Zuo, Beijing (CN); Wei Wen, Beijing (CN)

(73) Assignee: SAMSUNG ELECTRONICS CO., LTD., Suwon-si (KR)

(21) Appl. No.: 18/808,885

(22) Filed: Aug. 19, 2024

Related U.S. Application Data
(63) Continuation of application No. PCT/KR2024/011422, filed on Aug. 2, 2024.

(30) Foreign Application Priority Data
Feb. 27, 2023 (CN) 202311830300.8

(51) Int. Cl. G06T 5/60; G06T 5/50; G06T 7/73; G06V 10/74

(52) U.S. Cl. CPC G06T 5/60; G06T 5/50; G06T 7/73; G06V 10/761; G06T 2207/20221

(57) ABSTRACT

A method performed by an electronic device, includes acquiring a first image comprising at least a first region and a second region and a target object to be moved in the first image from the second region to the first region; and performing target object removal processing on the first image using a first artificial intelligence (AI) network based on guidance information related to at least one of first region and the second region, wherein the second region is a region of the target object in the first image in which the target object is located prior to the removal processing.

### CROSS-REFERENCE TO RELATED APPLICATION(S)

This application is a continuation of PCT International Application No. PCT/KR2024/011422, which was filed on Aug. 2, 2024, and claims priority to Chinese Patent Application No. 202311830300.8, filed on Dec. 27, 2023, the disclosures of each of which are incorporated by reference herein their entirety.

### BACKGROUND

### 1. Field

The present disclosure relates to the technical field of image processing, and particularly relates to a method performed by an electronic device, an electronic device, a storage medium, and a program product.

### 2. Description of Related Art

Image object reposition has become an important function of smartphones for reposition objects such as objects or people in images. For example, after taking a photograph, a user finds the object in a poor position and typically wants to edit the position of the object while leaving other image features substantially unchanged.

Image object reposition requires the generation of a background in a region of the image where the object is erased and the generation of a harmonious object in a region where the object needs to be placed, which places high demands on image processing techniques. Existing image object reposition methods often result in unnatural and unrealistic results after editing the object position.

### SUMMARY

The purpose of the embodiments of the present application is to solve the problem that existing image object reposition methods result in unnatural and unrealistic results after editing the object reposition.

According to an embodiment, a method performed by an electronic device may include acquiring a first image comprising at least a first region and a second region, and a target object to be moved in the first image from the second region to the first region. The method may include performing target object removal processing on the first image using a first artificial intelligence (AI) network based on guidance information related to at least one of the first region and a second region, wherein the second region is a region of the target object in the first image in which the target object is located prior to the removal processing.

According to an embodiment, an electronic device may include a memory storing instructions and a processor configured to retrieve the instructions that cause the processor to acquire a first image comprising at least a first region and a second region and a target object to be moved in the first image from the second region to the first region. The processor may be configured to perform target object removal processing on the first image using a first artificial intelligence (AI) network based on guidance information related to at least one of the first region and a second region, wherein the second region is a region of the target object in the first image in which the target object is located prior to the removal processing.

According to an aspect of the disclosure, a computer-readable storage medium having instructions stored therein, which when executed by a processor cause the processor to execute a method.

### BRIEF DESCRIPTION OF THE DRAWINGS

In order to more clearly illustrate the technical solutions in the embodiments of the present application, the accompanying drawings that need to be used in the description of the embodiments of the present application will be briefly introduced below.

FIG. 1 is a schematic diagram of a flow of a method performed by an electronic device according to one or more embodiments of the present application;

FIG. 2 is a schematic diagram of determining a target object and a repositioned region based on a user's operation according to one or more embodiments of the present application;

FIG. 3 is a schematic diagram of a first image and a second image according to one or more embodiments of the present application;

FIG. 4 is a schematic diagram of an overall processing flow of image object reposition according to one or more embodiments of the present application;

FIG. 5 is a schematic diagram of a processing flow of second image feature extraction of a target object according to one or more embodiments of the present application;

FIG. 6 is a schematic diagram of a training method for a Tiny ViT network according to one or more embodiments of the present application;

FIG. 7 is a schematic diagram of an overall processing flow of another image object reposition according to one or more embodiments of the present application;

FIG. 8 is a schematic diagram of performing correction processing on a first repair result based on first guidance information, second guidance information, and third guidance information according to one or more embodiments of the present application;

FIG. 9 is a schematic diagram of performing total probability sampling according to one or more embodiments of the present application;

FIG. 10 is a schematic diagram of determining a first repair result based on a third repair result and a second repair result according to one or more embodiments of the present application;

FIG. 11 is a schematic diagram of an example of a processing flow of another second image feature extraction of a target object according to one or more embodiments of the present application;

FIG. 12 is a schematic diagram of calculating an expected repair result according to one or more embodiments of the present application;

FIG. 13 is a schematic diagram of a processing flow of a method for sampling a first repair result according to one or more embodiments of the present application;

FIG. 14 is a schematic diagram of several cases of first repair results according to one or more embodiments of the present application;

FIG. 15 is a schematic diagram of correcting a first repair result according to one or more embodiments of the present application;

FIG. 16 is a schematic diagram of a similarity distance visualization update process according to one or more embodiments of the present application;

FIG. 17 is a schematic diagram of sampling from two mixed Gauss using Langevin dynamics according to one or more embodiments of the present application;

FIG. 18A is a schematic diagram of a Diffusion network according to one or more embodiments of the present application;

FIG. 18B is a schematic diagram of another Diffusion network according to one or more embodiments of the present application;

FIG. 18C is a schematic diagram of a Diffusion network combined sampling method according to one or more embodiments of the present application;

FIG. 18D is a schematic diagram of an overall processing flow of yet another image object reposition according to one or more embodiments of the present application;

FIG. 19A is a schematic diagram of a split operation of a current group normalization method;

FIG. 19B is a schematic diagram of a read and write operation of a current group normalization method;

FIG. 20A is a schematic diagram of a split operation of a group normalization method according to one or more embodiments of the present application;

FIG. 20B is a schematic diagram of a read and write operation of a group normalization method according to one or more embodiments of the present application;

FIG. 21A is a schematic diagram of an application scene of an image object reposition method according to one or more embodiments of the present application;

FIG. 21B is a schematic diagram of an application scene of another image object reposition method according to one or more embodiments of the present application;

FIG. 22 is a schematic diagram of a flow of another method performed by an electronic device according to one or more embodiments of the present application; and

FIG. 23 is a schematic structural diagram of an electronic device according to one or more embodiments of the present application.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When a component is said to be “connected” or “coupled” to the other component, the component can be directly connected or coupled to the other component, or it can mean that the component and the other component are connected through an intermediate element. In addition, “connected” or “coupled” as used herein may include wireless connection or wireless coupling.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, operation, operation, constituent element, component or a combination thereof, but may not be construed to exclude the existence of or a possibility of addition of one or more other characteristics, numbers, operations, operations, constituent elements, components or combinations thereof.

The term “or” used in various embodiments of the present disclosure includes any or all of combinations of listed words. For example, the expression “A or B” may include A, may include B, or may include both A and B. When describing multiple (two or more) items, if the relationship between multiple items is not explicitly limited, the multiple items can refer to one, many or all of the multiple items. For example, the description of “parameter A includes A1, A2 and A3” can be realized as parameter A includes A1 or A2 or A3, and it can also be realized as parameter A includes at least two of the three parameters A1, A2 and A3.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

At least some of the functions in the apparatus or electronic device provided in the embodiments of the present disclosure may be implemented by an AI model. For example, at least one of a plurality of modules of the apparatus or electronic device may be implemented through the AI model. The functions associated with the AI can be performed through a non-volatile memory, a volatile memory, and a processor.

The processor may include one or more processors. At this time, the one or more processors may be general-purpose processors such as a central processing unit (CPU), an application processor (AP), etc., or a pure graphics processing unit, such as a graphics processing unit (GPU), a visual processing unit (VPU), and/or an AI specialized processor, such as a neural processing unit (NPU).

The one or more processors control the processing of input data according to predefined operating rules or artificial intelligence (AI) models stored in the non-volatile memory and the volatile memory. The predefined operating rules or AI models are provided by training or learning.

In one or more examples, providing, by learning, refers to obtaining the predefined operating rules or AI models having a desired characteristic by applying a learning algorithm to a plurality of learning data. The learning may be performed in the apparatus or electronic device itself in which the AI according to the embodiments is performed, and/or may be implemented by a separate server/system.

The AI models may include a plurality of neural network layers. Each layer has a plurality of weight values. Each layer performs the neural network computation by computation between the input data of that layer (e.g., the computation results of the previous layer and/or the input data of the AI models) and the plurality of weight values of the current layer. Examples of neural networks include, but are not limited to, a convolutional neural network (CNN), a deep neural network (DNN), a recurrent neural network (RNN), a restricted Boltzmann machine (RBM), a deep belief network (DBN), a bi-directional recurrent deep neural network (BRDNN), generative adversarial networks (GANs), deep Q-networks, or any other suitable neural network known to one of ordinary skill in the art.

According to one or more embodiments, the learning algorithm is a method of training a predetermined target apparatus (e. g., a robot) by using a plurality of learning data to enable, allow, or control the target apparatus to make a determination or prediction. Examples of the learning algorithm include, but are not limited to, supervised learning, unsupervised learning, semi-supervised learning, or reinforcement learning.

The method provided in the present disclosure may relate to one or more of technical fields such as speech, language, image, video, and data intelligence.

In one or more examples, when referring to the field of images or videos, according to the present application, in an image object reposition method performed in an electronic device, a method for performing target object removal processing may obtain output data identifying an image or a removal processing result in an image using image data as input data of an AI model. The AI model may be obtained by training. In one or more examples, “obtained by training” means that a basic AI model is trained with a plurality of training data through a training algorithm to obtain a predefined operation rule or AI model configured to perform a desired feature (or purpose). The methods of the present application may relate to the field of visual understanding of AI techniques, which is a technique for identifying and processing things like human vision and includes, for example, object identification, object tracking, image retrieval, human identification, scene identification, 3D reconstruction/localization, or image enhancement.

The technical solutions of the embodiments of the present application and the technical effects produced by the technical solutions of the present application are described below through the description of several alternative embodiments. It should be noted that the following implementations may be referred to, borrowed, or combined with each other, and the same terms, similar features, and similar implementation operations in different implementations will not be repeated.

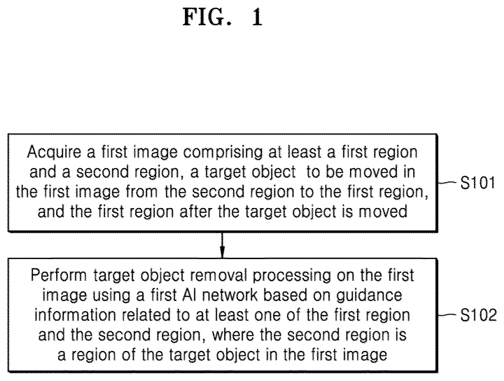

In the embodiments of the present application, there is provided a method performed by an electronic device, as shown in FIG. 1, including the following operations.

At S101, a first image, a target object to be moved in the first image, and a first region after the target object is moved are acquired.

In the embodiments of the present application, the first image refers to an image for which image object reposition (e.g., target object to be moved) is to be performed. In examples, the first image may be a stored image, for example, an image selected in an album for image object reposition; In one or more examples, the first image may be an image to be stored, for example, an image captured in real time by a camera for image object reposition and then stored. The embodiments of the present disclosure are independent of the source and function of the first image.

The embodiments of the present disclosure are independent of a type of the target object. In one or more examples, the target object may refer to, a person, a pet, a plant, a building, an item, etc., but is not limited thereto.

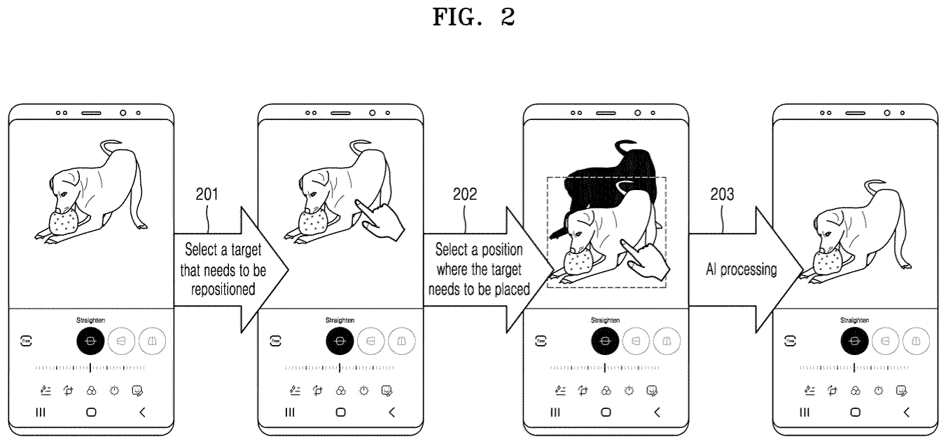

In the embodiments of the present application, the target object to be moved in the first image and the first region after the target object is moved may be determined based on a user's operation. In one or more examples, as shown in FIG. 2, at 201, a target that needs to be repositioned (e.g., the target object to be moved in the first image) may be determined in response to a first selection operation of the user. At 202, a position where the target needs to be placed (e.g., the first region after the target object is moved, which may also be referred to as a destination region) is determined in response to a second selection operation of the user. Then, at 203, target object removal processing is performed on the first image using the first AI network (i.e. AI processing) through the subsequent S102.

It will be appreciated that the manner in which each selection operation is performed may be set according to actual situations, for example, the user may perform relevant operations by clicking, double-clicking, gesturing, long-pressing, dragging and dropping, moving, voice, etc. but is not limited thereto.

At S102, target object removal processing is performed on the first image using a first AI network based on guidance information related to the first region and/or a second region.

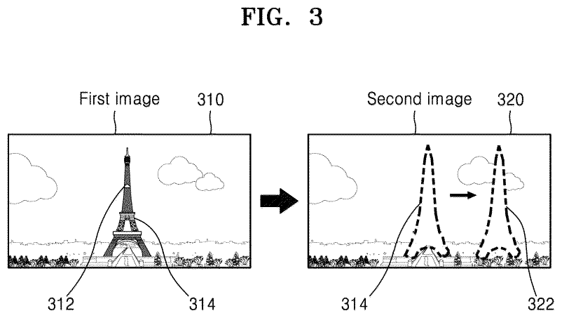

In one or more examples, the second region 314 is a region of the target object 312 in the first image 310 (e.g., may also be referred to as an original region). In an embodiment of the present application, an image after the first region 322 and the second region 314 are removed from the first image is referred to as a second image 320 (e.g., may also be referred to as a known position image or a background image, and for the convenience of description, a non-empty region in the image may hereinafter be referred to as a known position region or a background region), as shown in FIG. 3.

In an embodiment of the present application, content of the first region 322 and the second region 314 may be generated using an AI algorithm. In an embodiment, a natural and realistic background may be generated in the second region, and a harmonious target object may be generated in the first region, e.g., moving the target object from the second region to the first region may be realized.

In an embodiment of the present application, in the process of the first AI network performing target object removal processing on the first image, the guidance information related to the first region and/or the second region is used so that the first AI network may output a natural and realistic removal processing result.

In one or more examples, the first AI network may perform the target object removal processing on the first image using a Diffusion process of a Diffusion network model (e.g., usually being a U-net structure, which may also be referred to as a denoising U-net network, where the U-net network is a network containing a jump connection). However, a type of the first AI network is not limited thereto, and may also be other neural network models. A person skilled in the art may set the type and training manner of the first AI network according to actual situations, and the embodiments of the present application are not limited herein.

In one or more examples, in order to recover more natural and realistic background content in the second region and generate more harmonious and natural target object content in the first region at the same time, the embodiments of the present application may provide a novel sampling method, which may modify a first repair result outputted by the first AI network to obtain the removal processing result after the target object removal processing is performed on the first image.

In an embodiment, Operation S102 may include the following operations.

At Operation S1021, the first repair result of performing the target object removal processing on the first image is obtained using the first AI network.

In one or more examples, the first repair result of performing the target object removal processing on the first image may be obtained using the second image (or a feature extracted therefrom) and the target object (or a feature extracted therefrom) as inputs of the first AI network.

At Operation S1022, correction processing may be performed on the first repair result based on the guidance information related to the first region and/or the second region to obtain a removal processing result of performing the target object removal processing on the first image.

In an embodiment of the present application, the first repair result processed by the first AI network may be adjusted using the guidance information related to the first region and/or the second region so that a sampling probability of the first region for the target object content may become greater, a sampling probability of the second region for the background region content may become greater, and a sampling probability of the background region of the removal processing result for the original background region content of the second image may become greater so that more natural and realistic background content may be recovered in the second region, and natural and harmonious target object content may be generated in the first region.

Taking the first AI network using the Diffusion network model as an example, Operation S102 may include: the target object removal processing is performed on the first image using the first AI network based on an image feature of the target object, the second image, and a first noise.

In one or more examples, the first noise may be a random noise, but is not limited thereto.

In an embodiment of the present application, the image feature of the target object may be first extracted through a feature extraction network. In one or more examples, the feature extraction network may be a Tiny ViT (a small transformer) network and may also be other feature extraction networks, and the embodiments of the present application are not limited herein.

In an embodiment, the extracted image feature of the target object, the second image, and the first noise may be inputted into the first AI network to obtain the removal processing result of performing the target object removal processing on the first image.

In one or more examples, the method may include: a second noise is added to the second image to obtain a third image.

In an embodiment of the present application, the target object removal processing is performed on the first image using the Diffusion network model, the second noise may be added to the background image lacking the original region and the destination region, and the image is repaired by denoising through a diffusion process of the first AI network. In one or more examples, the first noise may be a standard Gaussian noise, but is not limited thereto.

In an embodiment of the present application, considering that the Diffusion network may remove the noise operation by operation, each operation may only repair a little content, and the content repair of a current operation may be performed on a repair result of a previous operation. In an embodiment, different degrees of second noise may be added to the second image as input for each operation of the diffusion process of the Diffusion network. A degree difference of adding the second noise to the second image may correspond to a degree of each repair of the first AI network (e.g., which may also be referred to as a dynamic diffusion denoising operation size). A specific degree value may be set according to actual situations, the first AI network is trained, and the embodiments of the present application are not limited herein.

In an embodiment of the present application, a variational auto-encoder (VAE) encoder network may also be used to compress an image into a hidden variable space, also referred to as a potential space. The target object removal processing is performed in the potential space so that dimensions of the model may be reduced, making the image processing process faster. After the target object removal processing is completed, a VAE decoder network may be used to convert an encoding result to a pixel space, and an image after the target object removal may be obtained.

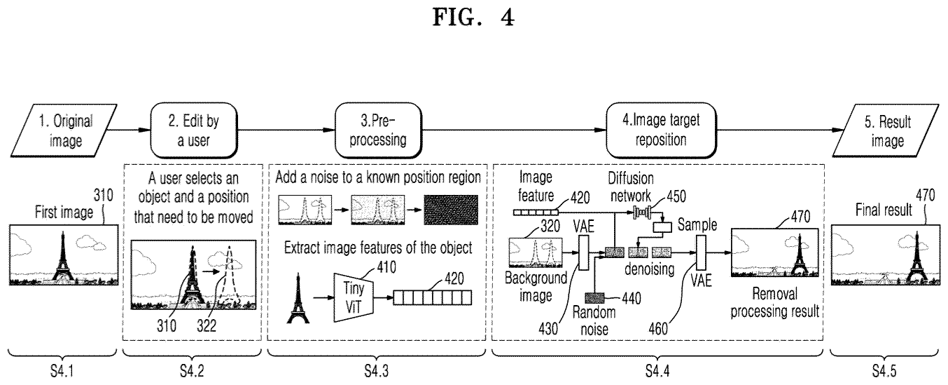

In an embodiment, as shown in FIG. 4, an embodiment of the present application provide an example of an overall processing flow of image object reposition, including:

At Operation S4.1, an original image (i.e., the first image 310) to be repositioned is determined.

At Operation S4.2, the user edits the original image 310 and selects the target object 312 that needs to be repositioned and a position (i.e., the first region 322) where the target object 312 is placed.

At Operation S4.3, image features of the target object 420 that needs to be repositioned are extracted using Tiny ViT 410, and the standard Gaussian noise is added to the background image (i.e., the second image 320) lacking the original region (i.e., the second region 314) and the destination region (i.e., the first region 322). This process may also be understood as a pre-processing process.

At Operation S4.4, according to extracted image features of the target object 420, the background image (i.e., the second image) 320 after VAE encoding 430, and the random noise 440, multiple denoising are performed through the Diffusion network 450 and the above-mentioned novel sampling method, where the background image (i.e., the third image, which is not shown in FIG. 4) after adding noise may be used in the multiple denoising processes, and then the final denoising result is subjected to VAE decoding 460 to obtain the removal processing result 470.

At Operation S4.5, an image after the target object 470 is moved is outputted.

In an embodiment of the present application, for the above-mentioned novel sampling method, the guidance information related to the first region and/or the second region may be determined based on the first repair result.

In one or more examples, the guidance information may include at least one of:
(1) a first similarity value indicating a similarity between content of the second region in the first repair result and background content of the first image,
where the second region in the first repair result is adjusted using the similarity between the content of the second region in the first repair result and the background content of the first image indicated by the first similarity value so that the sampling probability of the second region for the background content is greater;
(2) a second similarity value between content of the target object and content of the first region in the first repair result,
where the first region in the first repair result is adjusted using the similarity between the content of the target object and the content of the first region in the first repair result indicated by the second similarity value so that the sampling probability of the first region for the target object content is greater; and
(3) a third similarity value indicating similarity between background content of the first repair result and the background content of the first image,
where the background region of the first repair result is adjusted using the similarity between the background content of the first repair result and the background content of the first image indicated by the similarity value so that a sampling probability of the background region for an original background region content in the first image is greater.

In one or more examples, a similarity value may be a number between 0-1 indicating a degree of similarity between two image features. For example, a similarity value of 1 may indicate that two features in an image exhibit a high degree of similarity, and a similarity value of 0 may indicated that two features in the image exhibit a low degree of similarity.

Based on the guidance information, correction processing may be performed on three regions (i.e., the second region, the first region, and the background region) in the first repair result so that the first AI network may recover natural and realistic background content in the second region and generate harmonious and natural target object content in the first region, while making the background region consistent with the original image.

In one or more examples, determining the guidance information related to the first region and/or the second region based on the first repair result may include Operation SA1: determining first guidance information based on the second region in the first repair result and a second region in a second repair result.

In one or more examples, the second repair result is a repair result that both the first region and the second region generate background content. The second region in the first repair result is adjusted using the second region in the second repair result, which may make the sampling probability of the second region for the background content greater.

In an embodiment, the first guidance information (which may also be referred to as guidance information 1) may be determined based on the second region in the first repair result and the second region in the second repair result, and correction processing is performed on the second region in the first repair result based on the first guidance information.

In one or more examples, the first guidance information may be determined based on a first similarity between the second region in the first repair result and the second region in the second repair result.

In one or more examples, the first similarity may be determining a cosine similarity distance between the second region in the first repair result and the second region in the second repair result, but is not limited thereto, and other similarity determination manners may also be used.

In one or more examples, determining the guidance information related to the first region and/or the second region based on the first repair result may include Operation SA2: determining second guidance information based on the target object and the first region in the first repair result.

In one or more examples, desired repair content of the first region is the target object content, and the first repair result of the first region may be adjusted using the target object, which may make the sampling probability of the first region for the target object content greater.

For example, the second guidance information (e.g., which may also be referred to as guidance information 2) may be determined based on the target object and the first region in the first repair result, and correction processing is performed on the first region in the first repair result based on the second guidance information.

In one or more examples, the second guidance information may be determined based on a second similarity between the target object and the first region in the first repair result.

In one or more examples, the second similarity value may be determining a cosine similarity distance between the target object and the first region in the first repair result, but is not limited thereto, and other similarity determination processes may also be used.

In one or more examples, determining the guidance information related to the first region and/or the second region based on the first repair result may include Operation SA3: determining third guidance information based on the second image and the region other than the first region and the second region in the first repair result.

The region other than the first region and the second region in the first repair result is the background region in the first repair result, and the second image may correspond to the first image after the first region and the second region are removed (e.g., the second image is the original background region of the first image). The background region in the first repair result may be adjusted using the second image, which may make the sampling probability of the background region for the original background region content greater.

In one or more examples, the third guidance information (e.g., which may also be referred to as guidance information 3) may be determined based on the second image and the region other than the first region and the second region in the first repair result, and correction processing is performed on the background region in the first repair result based on the third guidance information.

In one or more examples, a third similarity value between the second image and the region other than the first region and the second region in the first repair result may be determined as the third guidance information.

In one or more examples, the third similarity value may be determining a cosine similarity distance between the second image and the region other than the first region and the second region in the first repair result, but is not limited thereto, and other similarity determination processes may also be used.

In an embodiment of the present application, an exemplary implementation is provided for Operation SA2, which may include the following operations.

At Operation SA21, relevance information between different spatial positions of a first image feature of the target object may be extracted to obtain a second image feature of the target object.

At Operation SA22, the second guidance information may be determined based on the second image feature and the first region in the first repair result.

In one or more examples, the second image feature represents advanced semantic information of the target object, and the first repair result of the first region is adjusted using the second image feature, which may make the sampling probability of the first region for the target object content greater.

In an embodiment of the present application, a second image feature of the target object that needs to be repositioned may also be extracted using the feature extraction network. In one or more examples, the feature extraction network may be the Tiny ViT network and may also be other feature extraction networks, and the embodiments of the present application are not limited herein.

In an embodiment of the present application, an exemplary implementation is provided for Operation SA21, and the feature extraction process of the target object is divided into two stages, including the following operations.

At Operation SA211, the first image feature of the target object is extracted.

For the first AI network with powerful functions, such as the Diffusion network, a harmonious result may be generated by only inputting image features such as a convolutional neural network (CNN) feature map, and the delay of extracting the CNN feature map is very low. Thus, at a first stage, the first image feature such as the CNN feature map may be extracted, but is not limited thereto.

At Operation SA212, the relevance information between different spatial positions of the first image feature of the target object may be extracted to obtain the second image feature of the target object.

Since, in an embodiment of the present application, the first repair result may be modified using the novel sampling method, in order to avoid affecting the harmonious result generated by the first AI network, guidance information may be added to maintain the harmonious effect. In one or more examples, at a second stage, guidance may be performed using the advanced semantic information, such as a corresponding text feature map.

For an embodiment of the present application, the advanced semantic information may be extracted based on the original image. For example, the relevance information between different spatial positions of the image features may be extracted, for example, a text feature map is extracted from the image features using an attention (Att) layer as the second image feature of the target object. Compared with direct guidance using the CNN feature map, the advanced semantic information omits information such as texture, illumination, and other details of the second region in the original image, avoiding the impact of such information on image harmony.

The first image feature and the second image feature may also be extracted using the feature extraction network. The feature extraction network may be the Tiny ViT network, but is not limited thereto.

In an embodiment of the present application, the feature extraction network may extract condition information (e.g., the first image feature), help the first AI network generate an image consistent with the target object in the first image in the first region, and may also guide the sampling method to keep semantic content of the target object unchanged after modifying the first repair result (e.g., using the second image feature).

Based on the extracted information, taking the first AI network using the Diffusion network model as an example, Operation S1021 may specifically include the following operations: the first repair result of performing the target object removal processing on the first image is obtained using the first AI network based on the first image feature, the second image, and the first noise.

In an embodiment of the present application, the first repair result of performing the target object removal processing on the first image is obtained using the second image, the first noise, and the first image feature as inputs of the first AI network.

Operation S1022 may include the following operations: the first repair result is modified based on the guidance information related to the first region and/or the second region, such as the second repair result, the second image feature, and/or the second image to obtain the removal processing result of performing the target object removal processing on the first image.

In an embodiment of the present application, the second repair result, the second image feature, and the second image are used as the guidance information. The first repair result processed by the first AI network is adjusted using the guidance information so that the sampling probability of the first region for the target object content is greater, the sampling probability of the second region for the background region content is greater, and the sampling probability of the background region of the removal processing result for the original background region content of the second image is greater so that more natural and realistic background content may be recovered in the second region, and natural and harmonious target object content may be generated in the first region.

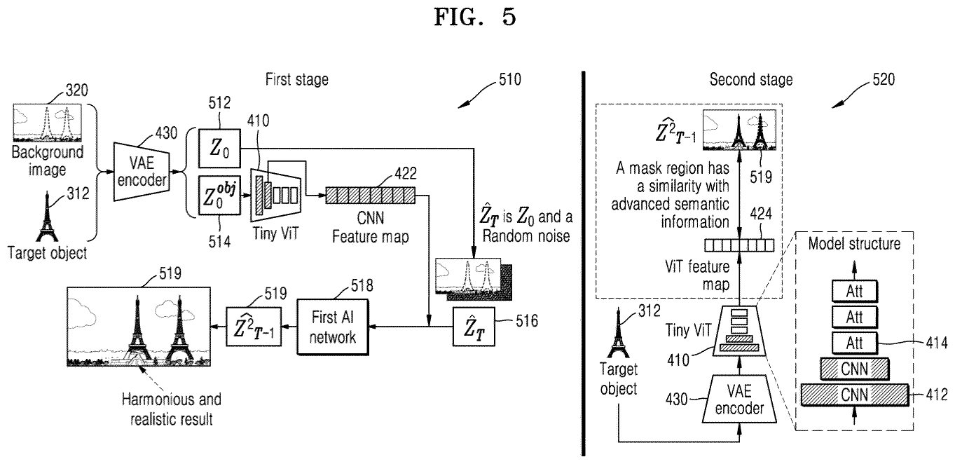

In an embodiment, as shown in FIG. 5, the embodiments of the present application provide an example of a processing flow of target second image feature extraction, including the following operations.

At a first stage, a background image 320 (i.e., the second image) is subjected to a VAE encoder 430 to obtain background image encoding Z₀ 512, and a target object image 312 is subjected to the VAE encoder 430 to obtain target object encoding Z₀^{obj} 514. A CNN feature map (i.e., the above-mentioned first image feature) 420 of the target object encoding Z₀^{obj} 514 is extracted using a CNN layer of the Tiny ViT (in the Tiny ViT network of FIG. 5, the CNN layer 412 indicated by a shaded part represents an ordinary convolution layer, and an Att layer 414 indicated by a non-shaded part represents a self-Att layer), a random noise (i.e., the first noise) 440 is added to the background image encoding Z₀ 512 to obtain encoding \hat{Z}_{T} 516, and the extracted CNN feature map 422 and the encoding \hat{Z}_{T} 516 are inputted into the first AI network 518 to output a harmonious and realistic encoding result [symbol] 519.

At a second stage, a ViT feature map 424 (i.e., the above-mentioned second image feature) of the target object encoding Z₀^{obj} 514 is extracted successively using the CNN layer 412 and the Att layer 414 of the Tiny ViT network 410, or a ViT feature map 424 corresponding to the CNN feature map 422 is extracted directly using the Att layer 414 of the Tiny ViT 410. The advanced semantic information included in the ViT feature map 424 has a high similarity with a mask region of the harmonious and realistic encoding result [symbol] 519, and the harmonious and realistic effect may be maintained in the process of modifying the first repair result of the first region by the above-mentioned novel sampling method. In FIG. 5, one or more features of the first stage may be performed in parallel with one or more features of the second stage.

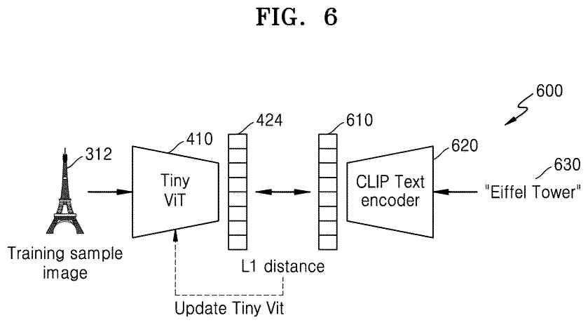

A training method of the Tiny ViT network may be as shown in FIG. 6 and specifically includes: inputting a training sample image 312 into the Tiny ViT 410 to extract the ViT feature map 424, and obtaining a word feature map 610 corresponding to words (such as “Eiffel Tower”) from a pre-trained contrastive language-image pre-training (CLIP) Text encoder 620. An L1 distance between the ViT feature map 424 and the word feature map 610 may be calculated as a loss function to update Tiny ViT network parameters so that the Tiny ViT network 410 is trained.

The target second image feature extraction method provided in an embodiment of the present application may take the extracted CNN feature map as the condition information to help a diffusion model generate a similar original target object in the destination region, and take the ViT feature map as the guidance information to guide sampling to ensure that the above-mentioned novel sampling method keeps the semantic content of the target object unchanged after modifying an output result of the diffusion model.

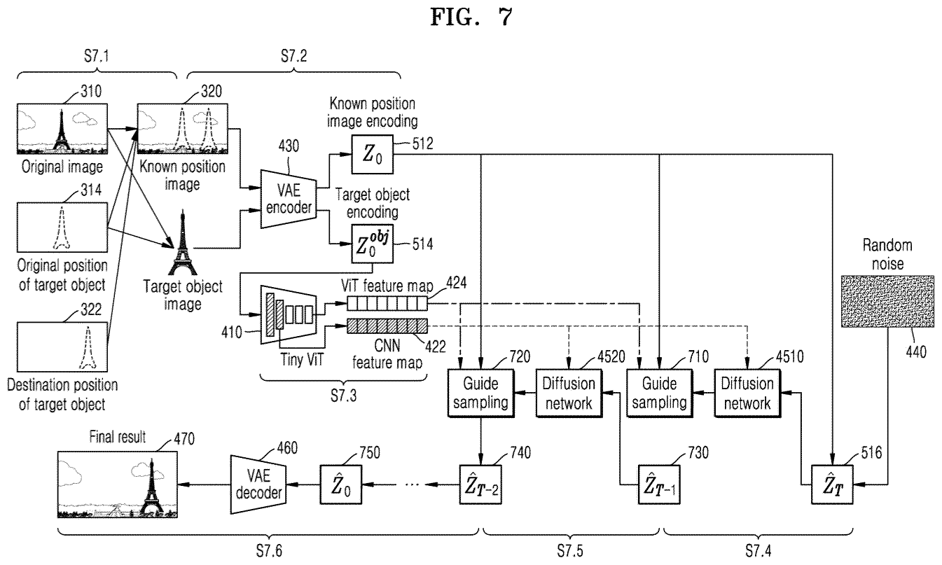

In an embodiment of the present application, based on the feature extraction processes of the two-stage target object, an example of an overall processing flow of another image object reposition is shown in FIG. 7. In an embodiment, the flow contains a VAE network, a Tiny ViT network, a Diffusion network, and a sampling module and may include the following operations.

At Operation S7.1, a known position image (i.e., the second image 320) may be obtained using an original image (i.e., the first image 310), an original position (i.e., the second region 314) of a target object, and a destination position (i.e., the first region 322) of the target object; and a target object image 312 may be obtained using the original image (i.e., the first image 310) and the original position (i.e., the second region 314) of the target object.

At Operation S7.2, the known position image (i.e., the second image 320) may be subjected to the VAE encoder 430 to obtain the known position image encoding Z₀ 512, and the target object image is subjected to the VAE encoder 430 to obtain the target object encoding Z₀^{obj} 514.

At Operation S7.3, two stages of feature extraction may be performed on the target object encoding Z₀^{obj} 514 using the Tiny ViT network 410 to obtain a CNN feature map 422 (i.e., the above-mentioned first image feature) and a ViT feature map 424 (i.e., the above-mentioned second image feature). The CNN feature map 422 may be inputted into the Diffusion network as the condition information, and the ViT feature map 424 is used as the guidance information to guide sampling.

At Operation S7.4, the encoding \hat{Z}_{T} may be obtained using the known position image encoding Z₀ 512 and the random noise 440 (i.e., the first noise), combining the extracted CNN feature map 422 as an input of a first iteration of the Diffusion network 4510, an output result of the Diffusion network combined with the extracted ViT feature map 424 is inputted into a guiding sampling module 710, and denoising result encoding \hat{Z}_{T-1} 730 may be outputted.

At Operation S7.5, the previous outputted denoising result encoding \hat{Z}_{T-1} combined with the extracted CNN feature map 422 may be taken as an input of this iteration of the Diffusion network 4520, an output result of the Diffusion network at this time combined with the extracted ViT feature map 424 may be inputted into the guiding sampling module 720, and the denoising result encoding \hat{Z}_{T-2} 740 at this time is outputted.

At Operation S7.6, Operation S7.5 is performed repeatedly until the last denoising result encoding \hat{Z}₀ 750 is outputted. The encoding \hat{Z}₀ 750 is converted to a pixel space using a VAE decoder 460 to obtain a final result image 470.

The image object reposition method provided by an embodiment of the present application may modify means and variances outputted by the Diffusion network through various guidance information. In an embodiment, an original region of the final result image is the background content, and a destination region is the target object content.

In an embodiment, S1022 may include the following operations: based on the first guidance information, the second guidance information, and the third guidance information, correction processing may be performed on three regions (i.e., the second region, the first region, and the background region) in the first repair result so that the first AI network may recover more natural and realistic background content in the second region and generate harmonious and natural target object content in the first region, while making the background region consistent with the original image.

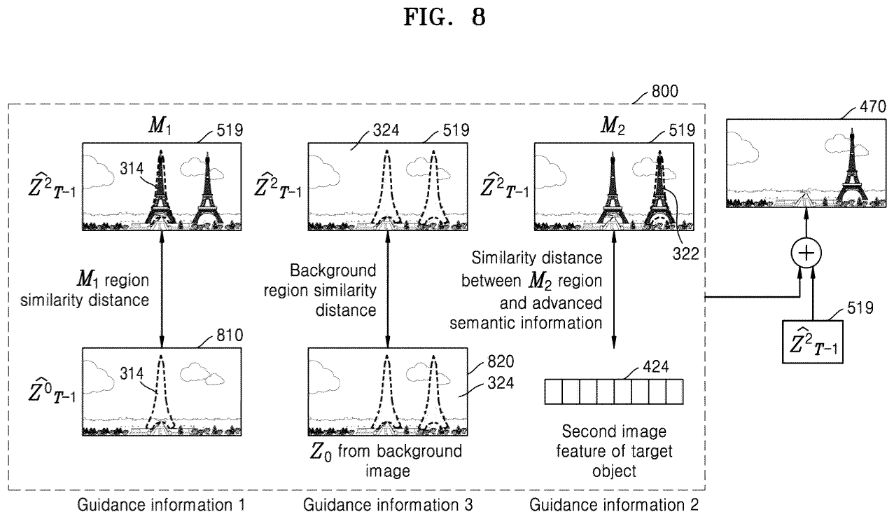

In one or more examples, as shown in FIG. 8, assuming [symbol] 519 representing the first repair result, a similarity distance between a M₁ region (i.e., the second region 314) in [symbol] 519 and a M₁ region 314 in [symbol] 810 (obtained from sampling of the second repair result 322) is determined to obtain guidance information 1, a similarity distance between a M₂ region 322 (i.e., the first region) in [symbol] 519 and a second image feature of a target object 424 is determined to obtain guidance information 2, and a similarity distance between a background region 324 of [symbol] 519 (i.e., not including the M₁ region and the M₂ region) and a background region 324 of Z₀ 820 (from a background image) is determined to obtain guidance information 3. Correction processing may be performed on [symbol] 519 based on the guidance information to obtain the removal processing result 470.

In an embodiment of the present application, an implementation may be provided for Operation S1021, which may include the following operations.

At Operation SB1, a third repair result in which both the first region and the second region generate content of the target object may be obtained using the first AI network based on the first image feature of the target object and the second image, and the second image is the image after the first region and the second region are removed from the first image.

If the first AI network is the Diffusion network, the operation may be obtaining the third repair result using the first AI network based on the first image feature of the target object, the second image, and the first noise.

In an embodiment of the present application, the second image may be combined with the first image feature of the target object to obtain the third repair result using the first AI network. Since the input takes the first image feature of the target object as the condition information, both the first region and the second region in the outputted third repair result may generate the target object content.

At Operation SB2, a fourth repair result that both the first region and the second region generate the background content may be obtained using the first AI network based on a preset feature and the second image.

If the first AI network is the Diffusion network, the operation may be obtaining the fourth repair result using the first AI network based on the preset feature, the second image, and the first noise.

The preset feature may be a blank feature and may also be a feature of a specific content, but is not limited thereto.

Taking the blank feature as an example, in an embodiment of the present application, the second image is combined with the blank feature to obtain the fourth repair result using the first AI network. Since the feature map of this input is empty, both the first region and the second region in the outputted fourth repair result generate the background content.

At Operation SB3, the first repair result is obtained based on the third repair result and the fourth repair result.

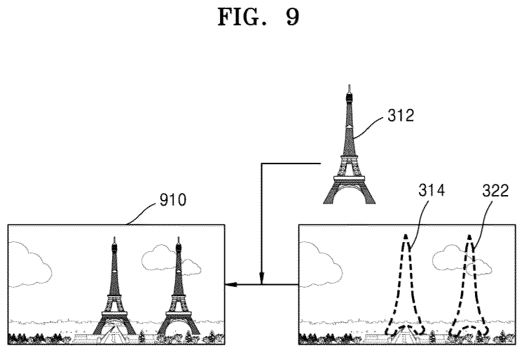

In one or more examples, the first repair result 519 may be a distribution result 910 of the first region 322 and the second region 314 containing the target object 312. In an embodiment of the present application, the distribution result may be determined based on the third repair result and the fourth repair result, and this operation may be understood as performing total probability sampling for filling the image features of the target object into missing regions (the first region and the second region), as shown in FIG. 9, to obtain the distribution result 910 of the first region 322 and the second region 314 containing the target object 312.

In one or more examples, Operation SB3 may include the following operations: the third repair result and the second repair result are fused, such as a weighted fusion, but not limited thereto. Sampling processing is performed on a fusion result and the second image to obtain the first repair result.

If the first AI network is the Diffusion network, the operation may be performing sampling processing on the fusion result, the second image, and the first noise to obtain the first repair result.

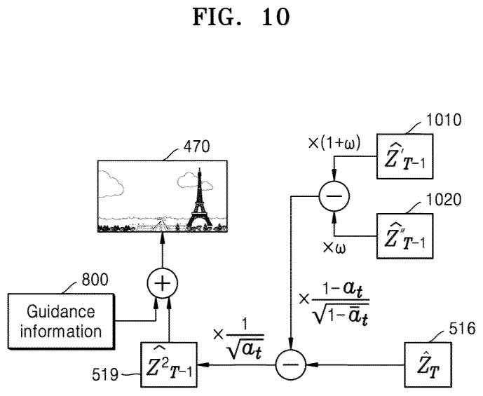

In one or more examples, as shown in FIG. 10, assuming that [symbol] represents the third repair result 1010 and [symbol] represents the second repair result 1020, weighted fusion is performed on the third repair result 1010 and the second repair result 1020 to obtain a fusion result 1030, and the manner may be:

$$\\ \times ( 1 + ω ) - \times {ω}_{,}$$

where 1+ω and ω are weights set for the third repair result 1010 and the second repair result 1020, and a specific weight value may be set according to actual situations, and the embodiments of the present application are not defined herein. In addition, the manner of fusing the third repair result and the second repair result is not limited to the above manner, and other fusion manners may be used, and the embodiments of the present application are not defined herein.

In an embodiment, a sampling processing may be performed based on the fusion result and the second image. In FIG. 10, \hat{Z}_{T} represents the second image 516 (if the first AI network is the Diffusion network, \hat{Z}_{T} may represents the second image adding the first noise). The \hat{Z}_{T} 516 and the fusion result may be processed by standard sampling methods (such as denoising diffusion implicit models (DDIM) or denoising diffusion probabilistic models (DDPM), but not limited thereto) to obtain a first repair result [symbol] 519 that the first region 322 and the second region 314 containing the target object 312.

In one or more examples, referring to FIG. 10, the sampling process may be expressed as:

$$\\ = \{ [ \times ( 1 + ω ) - \times ω ] \times \frac{1 - {α}_{t}}{\sqrt{1 - {\overline{α}}_{t}}} - {\hat{Z}}_{T} \} \times \frac{1}{\sqrt{{α}_{t}}} \frac{1 - {α}_{t}}{\sqrt{1 - {\overline{α}}_{t}}} and \frac{1}{\sqrt{{α}_{t}}}$$

are set coefficients, and αₜ is related to a noise level.

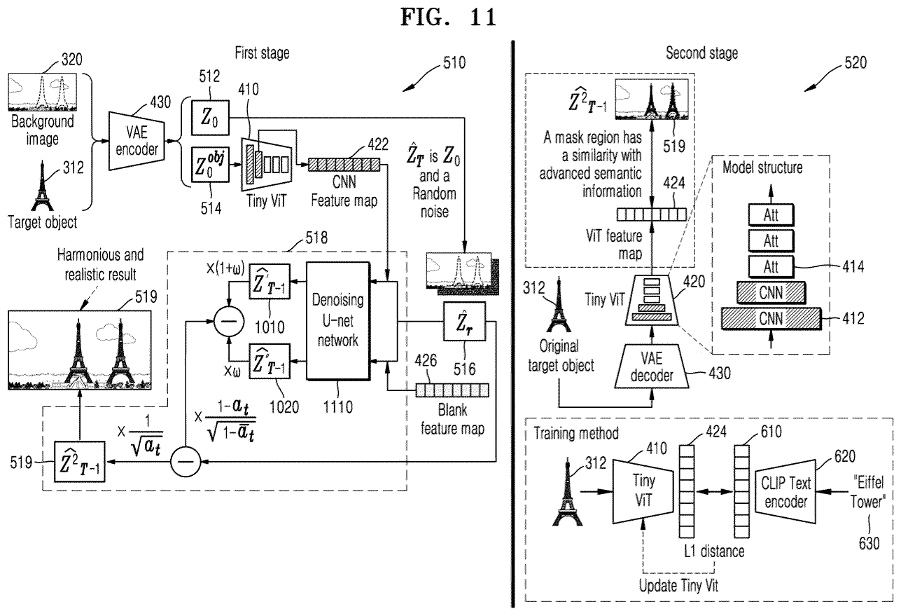

In one or more examples, a first repair result determination method shown in FIG. 10 may be combined with the target second image feature extraction method shown in FIG. 5. As shown in FIG. 11, after extracting and obtaining the CNN feature map of the target object, the extracted CNN feature map 322 and the encoding \hat{Z}_{T} 516 are inputted into the first AI network 518 to obtain a third repair result [symbol] 1010, a blank feature map 426 and the encoding \hat{Z}_{T} 516 are inputted into the first AI network 518 to obtain a second repair result [symbol] 1020, and then the first repair result [symbol] 519 is determined by the method shown in FIG. 10. Further, after extracting and obtaining the ViT feature map 424 of the target object 312, correction processing may be performed on the first repair result 519 based on the guidance information 800 to obtain the removal processing result 470. For the incomplete details in FIG. 11, such as extraction methods of the CNN feature map 422 and the ViT feature map 424, the training method of the feature extraction network, and the guiding sampling process, reference may be made to the description of FIG. 5, FIG. 6, and FIG. 10, which will not be described in detail herein.

In an embodiment of the present application, an exemplary implementation is provided for Operation SA1, which may include the following operations: sampling processing is performed on the second repair result and the second image to obtain the fourth repair result. The first guidance information may be determined based on the second region in the first repair result and the second region in the fourth repair result.

If the first AI network is the Diffusion network, the operation may be performing sampling processing based on the second repair result, the second image, and the first noise, and adding a third noise to obtain the fourth repair result. In one or more examples, the third noise may be a random noise, but is not limited thereto.

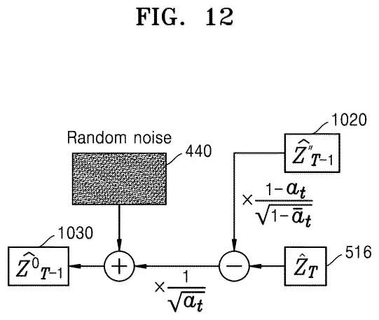

As shown in FIG. 12, it is assumed that [symbol] represents the second repair result 1020, and \hat{Z}_{T} 516 represents the second image 320 (if the first Alnetwork is the Diffusion network, \hat{Z}_{T} may represent the second image and the first noise). \hat{Z}_{T} 516 and [symbol] 1020 may be processed by standard sampling methods (such as DDTM or DDPM, but not limited thereto), and a random noise (i.e., the third noise) is added to obtain a result (fourth repair result) [symbol] 1030 that both the first region 322 and the second region 314 generate a background. The sampling process may be expressed as:

$$\\ = ( \times \frac{1 - {α}_{t}}{\sqrt{1 - {\overline{α}}_{t}}} - {\hat{Z}}_{T} ) \times \frac{1}{\sqrt{{α}_{t}}} + Random Noise , where$$

$$\\ \frac{1 - {α}_{t}}{\sqrt{1 - {\overline{α}}_{t}}} and \frac{1}{\sqrt{{α}_{t}}}$$

are set coefficients, αₜ is related to a noise level, and at

### Random Noise Represents a Random Noise.

In one example, [symbol] may be a repair result 1020 of the blank feature map 426. Therefore, when using the standard sampling method, the missing regions (the first region and the second region) will be filled with the background content.

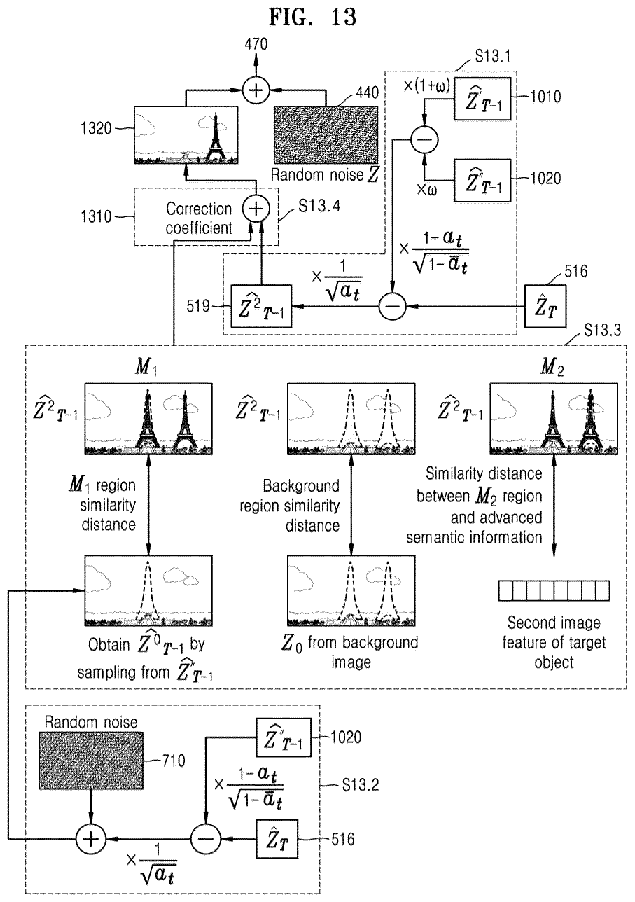

In an embodiment, as shown in FIG. 13, an embodiment of the present application provides an example of a processing flow of a method for sampling the first repair result, specifically including the following operations.

At Operation S13.1, the third repair result [symbol] 1010 and the second repair result [symbol] 1020 may be combined to determine a total probability distribution mean [symbol] 519 of the missing regions (the first region 322 and the second region 314) containing the target object content 312. A specific determination manner may be seen from the description of FIG. 10 and will not be described in detail herein.

At Operation S13.2, \hat{Z}_{T} 516 (the second image adding the first noise) and [symbol] 1020 are processed using the standard sampling method (such as the DDIM) to obtain [symbol] 1030 (the fourth repair result) that both the first region and the second region generate a background. A specific determination manner may be seen from the description of FIG. 12 and will not be described in detail herein.

At Operation S13.3, similarity distances between [symbol] and [symbol] , the second image feature of the target object, and the known position image are determined as the guidance information 800. For example, a similarity distance between the a M₁ region (i.e., the second region) of [symbol] and a M₁ region of [symbol] , a similarity distance between a M₂ region (i.e., the first region) of [symbol] and the second image feature of the target object, and a similarity distance between a background region of [symbol] and a background region of Z₀ are determined. A specific determination manner may be seen from the description of FIG. 8 and will not be described in detail herein.

At Operation S13.4, the total probability distribution mean [symbol] 519 may be corrected by calculating the correction coefficient 1310 through the guidance information 800 to ensure that the M₂ region 322 generates the target object 312, and the M₁ region 314 recovers the background to obtain a conditional probability distribution mean [symbol] 1320, and then a random noise 440 may be added to obtain the removal processing result 470.

In an embodiment of the present application, an exemplary implementation is provided for Operation S1022, which may include the following operations: a correction coefficient corresponding to the first repair result may be determined based on the guidance information related to the first region and/or the second region; correction processing is performed on the first repair result based on the correction coefficient.

In one or more examples, a derivative operation for the first repair result may be performed on the guidance information related to the first region and/or the second region to obtain the correction coefficient.

In an embodiment of the present application, the first repair result [symbol] contains the target object in both the first region and the second region. In order to fill a finally generated image with background in the second region, where the background region is consistent with the background region of the original image, while containing the inputted target object in the first region, the first repair result [symbol] may be modified to change [symbol] from the total probability distribution (e.g., the two regions contain the target object content) to the conditional probability distribution (the second region fills the background, and the first region still generates the target object).

In one or more examples, the modification process may be based on Langevin dynamics.

In one or more examples, for the determined guidance information, such as each similarity distance, a derivative of [symbol] (i.e., a partial derivative of [symbol] ) is taken, and then the distribution of [symbol] may be corrected using a derivative result according to Langevin [symbol] dynamics.

In an embodiment of the present application, performing a derivative operation for the first repair result on the guidance information related to the first region and/or the second region to obtain the correction coefficient may include: determining a gradient of a result of the derivation operation; and determining a direction and/or a degree of modification of the first repair result as the correction coefficient based on the gradient.

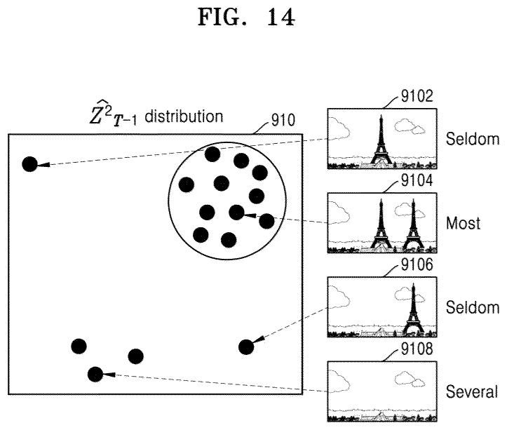

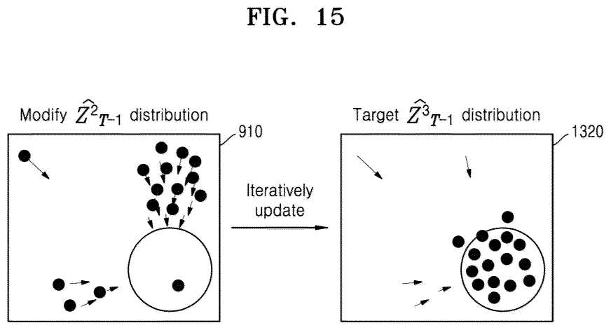

For an embodiment of the present application, an example solution for correcting [symbol] distribution is shown in FIG. 14 and FIG. 15. FIG. 14 shows several cases of the [symbol] distribution. As shown in 9104, In most cases, a [symbol] distribution result 910 (i.e., the first repair result) includes the target object in the two regions, and it is difficult to have a case where only the first region contains the target object as shown in 9106, or only the second region contains the target object as shown in 9102, and a case where several of the two regions are backgrounds (neither contains the target object) as shown in 9108. FIG. 15 is a goal of correcting the [symbol] distribution 910, and in order to modify the [symbol] distribution result 910, the guidance information 800 may be used to obtain an update direction and/or degree and iteratively update the distribution result to obtain a target distribution result [symbol] 1320 satisfying the requirement.

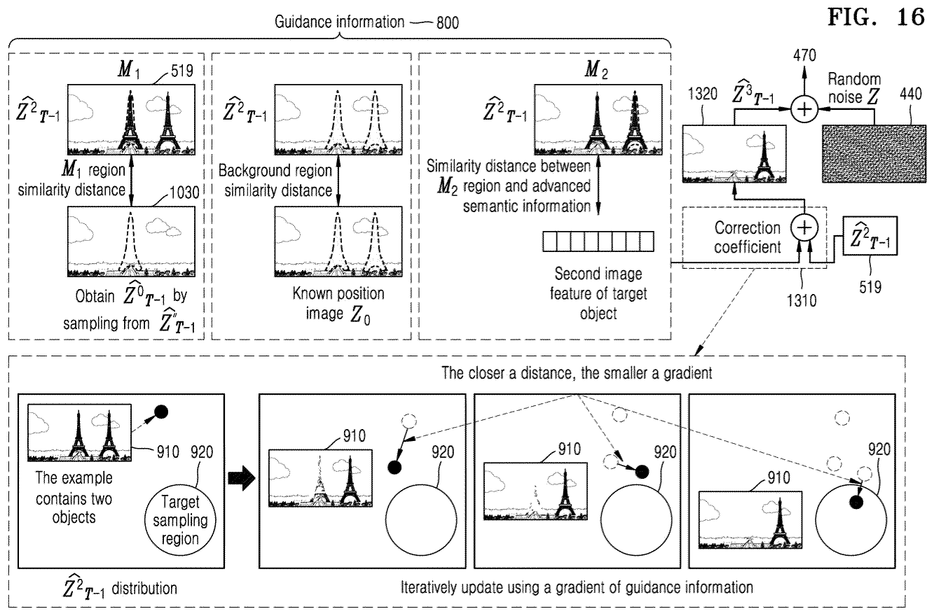

In one or more examples, in the process of correcting the total probability distribution mean [symbol] 910 by determining the correction coefficient 1310 through the guidance information 800 (a determination manner of the guidance information may be seen from the description of FIG. 8 and will not be described in detail herein), referring to FIG. 16, taking a M₁ region similarity distance visualization update process as an example, the gradient may be taken from the similarity distance between the determined [symbol] 519 and [symbol] 1030. In one example, the obtained [symbol] distribution 910 may contain two target objects, which need to be updated to a target sampling region, and the [symbol] distribution 910 may be updated iteratively using the gradient of the guidance information 800. When a distance between the [symbol] distribution 910 and the target sampling region 920 is larger, the similarity distance may be larger and the gradient may be larger, and when a distance between the [symbol] distribution 910 and the target sampling region 920 is smaller, the similarity distance may be smaller and the gradient m smaller. After the update is completed, distribution [symbol] 1320 in the target sampling region may be updated, and then a random noise 440 is added to obtain the removal processing result 470.

In one or more examples, distribution P(X) may be sampled using a scoring function ∇ₓ log_{P}(X) based on a distribution modification process of Langevin dynamics, and its iteration operation may be expressed as:

$$\\ {x}_{i + 1} = {x}_{i} + ϵ {∇}_{x} log P ( x ) + \sqrt{2 ϵ} {Z}_{i} ,$$

where xᵢ₊₁ represents distribution after the iteratively updating, xᵢ represents the distribution before the iteratively updating, ∈<<1, ∇ₓ log P(x) represents a trained scoring function, and Zᵢ˜N(0, I) is the standard Gaussian noise.

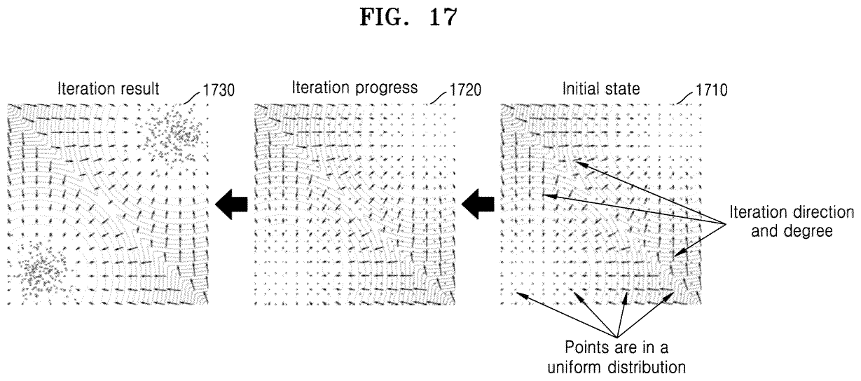

For example, as shown in FIG. 17, in the process of sampling from two mixed Gauss using Langevin dynamics, points being in a uniform distribution state initially at 1710, and iteratively updating the distribution using the scoring function ∇ₓ log P(X) at 1720, the iteration direction and degree of each point are as shown by each arrow in FIG. 17, and finally the iteration result 1730 shown in FIG. 17 is obtained.

In an embodiment of the present application, the [symbol] distribution may be modified into the [symbol] distribution based on Langevin kinetics, and the scoring function and the modification manner used may be expressed as the following process:

$$\\ = + {γ}_{1} ( {M}_{1} \times sim ( , ) ) + {γ}_{2} ( ( 1 - {M}_{1} ) \times ( 1 - {M}_{2} ) \times sim ( , {x}_{0} ) ) + {γ}_{3} ( {M}_{2} \times sim ( , F ) )$$

where γ₁ [symbol] (M₁×sim( [symbol] , [symbol] )) corresponds to a correction processing progress of the guidance information 1, γ₂ [symbol] ((1−M₁)×(1−M₂)×sim( [symbol] , x₀)) corresponds to a correction processing progress of the guidance information 3, and γ₃ [symbol] (M₂×sim( [symbol] ,F)) corresponds to a correction processing progress of the guidance information 2. x corresponds to Z, F represents the second image feature of the target object, and γ₁, γ₂, and γ₃ are corresponding coefficients. Taking the correction processing progress of the guidance information 1 as an example, sim( [symbol] , [symbol] ) represents a probability that the [symbol] distribution belongs to [symbol] , and a derivative of [symbol] is taken to obtain an updated gradient. When the probability is very high, it means that it is very similar to [symbol] , i.e., the similarity distance is very small and the corresponding gradient is very small. In an embodiment, if the probability is very small, a very large gradient change will be obtained. According to the gradient, the [symbol] distribution may be modified to satisfy the target distribution, and the correction processing progress of the guidance information 2 and the correction processing progress of the guidance information 3 are similar, which may not be described in detail.

In an embodiment of the present application, in order to remove noise operation by operation, an exemplary implementation is provided for Operation S102: performing the target object removal processing using the first AI network based on the target object and the second image to obtain a first removal processing result, the second image being the image after the first region and the second region are removed from the first image; and repeating the operation of performing the target object removal processing using the first AI network based on the target object and a last removal processing result until a set condition is reached to obtain the removal processing result of performing the target object removal processing on the first image.

A set condition may include, but are not limited to, a number of repeated executions reaching a predetermined number of times, or the output result reaching the set condition, and the embodiments of the present application are not defined herein.

If the first AI network is the Diffusion network, the operation may include: adding at least one second noise to the second image to obtain a corresponding third image. Operation S102 may then include: performing the target object removal processing using the first AI network based on the second image feature, the second image, and the first noise to obtain the first removal processing result; and repeating the operation of performing the target object removal processing using the first AI network based on the target object, the corresponding third image, and the last removal processing result until the set condition is reached to obtain the removal processing result of performing the target object removal processing on the first image.

In one or more examples, taking the first AI being the Diffusion network as an example, a diffusion method transforms a generation task into a prediction task so that a particular and accurate loss may be used to guide the network to output a high-performance result.

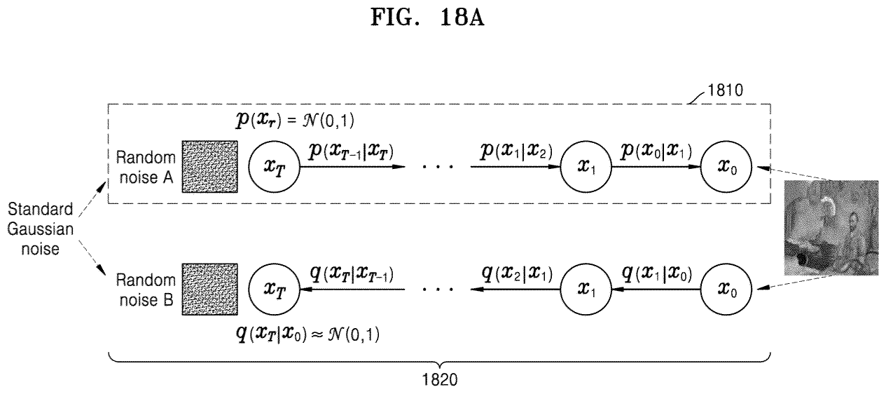

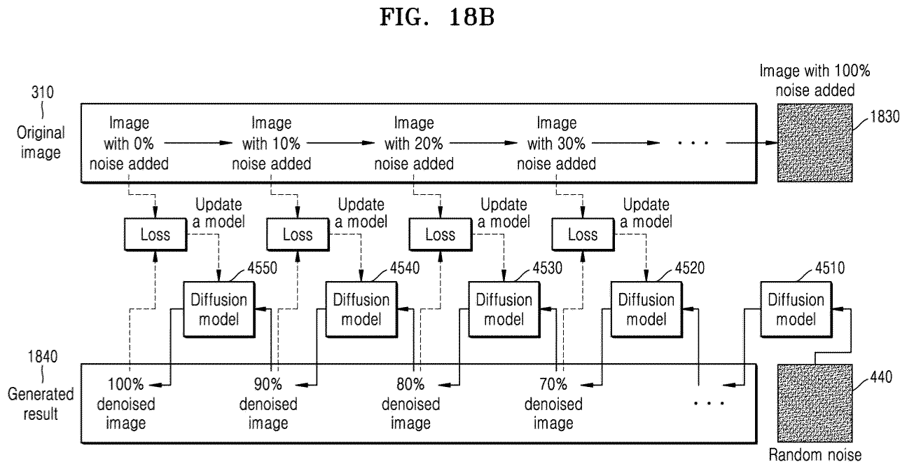

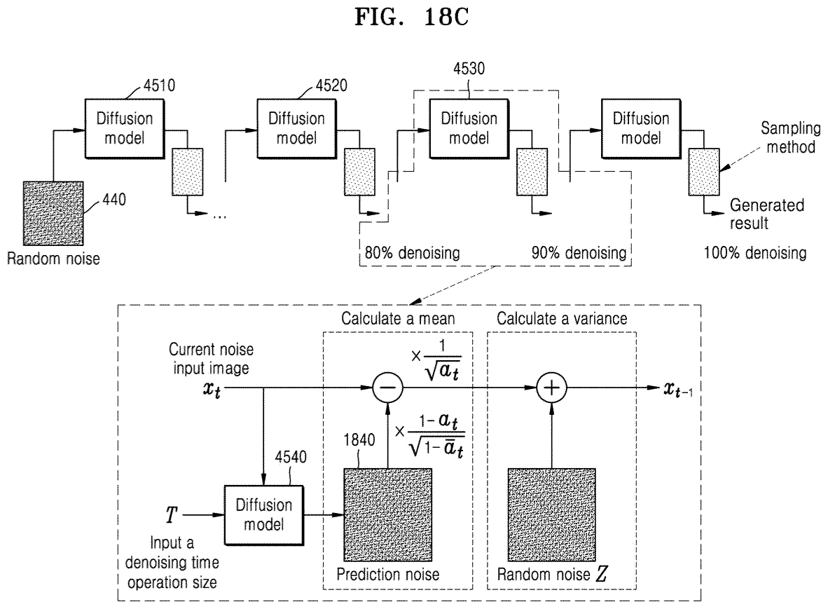

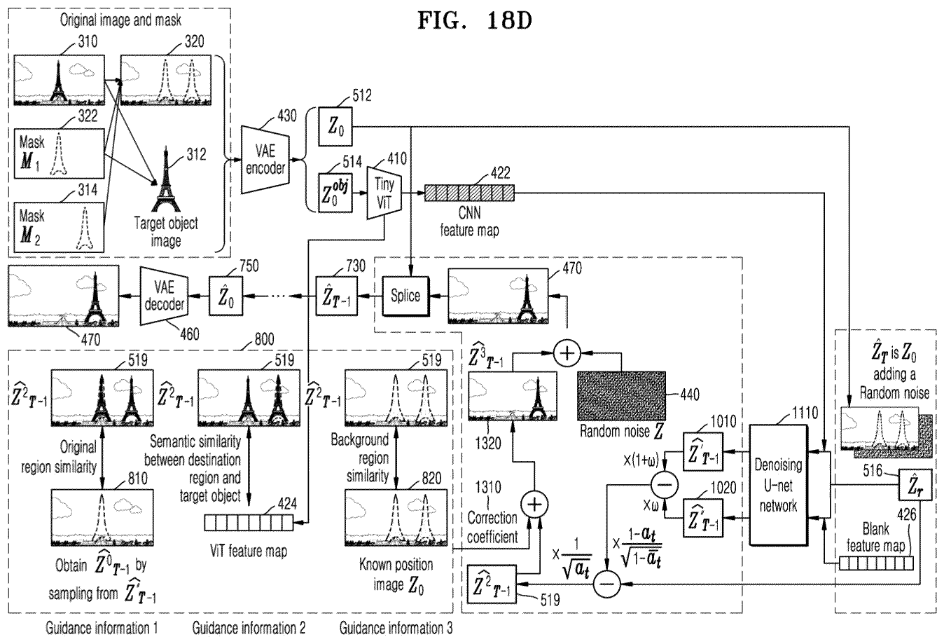

As shown in FIG. 18A, data distribution x₀˜q(x₀) is given, a random noise 440 is added to it operation by operation to generate a series of random variables x₁, x₂, . . . , x_{T}, and a transfer kernel is q(xₜ|xₜ₋₁) as shown in 1810. The denoising process 1820 is based on prior distribution p(x_{T})=N(0,I) and the transfer kernel p(xₜ₋₁|xₜ) which may be learned to realize the operation-by-operation denoising. The Diffusion network learns as much as possible of the noise added to current input data and then restores a high-performance image, and a loss of the Diffusion network is not a black box but very specific.

In one or more examples, the Diffusion network learns a degree of denoising according to a degree of noise added to the sample. The degree of denoising each time can be achieved by setting different training methods according to actual situations. For example, as shown in FIG. 18B, the Diffusion network 450 may be trained by the following manners. An original image 310 used for training is acquired, to which noise is continuously added until the original image is fully converted to random noise data 1830. The image with each addition of noise may be kept for the training phase to calculate the loss to update the Diffusion network. For each training, the Diffusion network may only need to predict the noise that needs to be removed in the current input image. For example, a 70% denoised image is inputted into the first AI network (e.g. Diffusion network) 4530, and the first AI network 4530 only needs to predict a denoised image of the current image, compares it with an image with 20% noise added to calculate the loss, and updates a model parameter. The updated Diffusion network may continue to be used for prediction, and similar prediction processes and model training processes may be carried out in this way and will not be described in detail herein.

In conjunction with the above-mentioned novel sampling method provided by the embodiments of the present application, as shown in FIG. 18C, a mean and a variance of data distribution of a denoising result of the diffusion model are calculated, the image may be sampled according to the data distribution, and the denoising result 1840 may be outputted. Taking one-time denoising and sampling processing as an example, x, is a current noise image, and T is a current denoising time operation size. xₜ and T may be inputted into the Diffusion network 4540, and the Diffusion network outputs a prediction noise 1840. The mean and the variance are calculated according to the formula in FIG. 18C, and a diffusion result xₜ₋₁ is outputted.

In an embodiment, an example of an overall processing flow of an image object reposition is shown in FIG. 18D, specifically including the following operations.

At Operation S18.1, a known position image (i.e., the second image 320) is obtained using an original image (i.e., the first image 310), an original position mask M₁ (i.e., the second region 314) of a target object, and a destination position mask M₂ (i.e., the first region 322) of the target object 312, and a target object image 312 is obtained using the original image (i.e., the first image 310) and the original position mask M₁ (i.e., the second region 314) of the target object.

At Operation S18.2, the known position image (i.e., the second image 314) is subjected to the VAE encoder 430 to obtain the known position image encoding Z₀ 512, and the target object image 312 is subjected to the VAE encoder 430 to obtain the target object encoding Z₀^{obj} 514.

At Operation S18.3, two stages of feature extraction are performed on the target object encoding Z₀^{obj} 514 using the Tiny ViT 410 to obtain a CNN feature map 422 (i.e., the above-mentioned first image feature) and a ViT feature map 424 (i.e., the above-mentioned second image feature). The CNN feature map 422 is inputted into the denoising U-net network 1110 (e.g., the first AI network 518) as the condition information, and the ViT feature map 424 is used as the guidance information 800 to guide sampling.

At Operation S18.4, the encoding \hat{Z}_{T} 516 is obtained using the known position image encoding Z₀ 512 and the random noise 440 (i.e., the first noise), the extracted CNN feature map 422 is inputted into the denoising U-net network 1110 to obtain a third repair result [symbol] 1010, and a blank feature map 426 and the encoding \hat{Z}_{T} 516 are inputted into the denoising U-net network 1110 to obtain a second repair result [symbol] 1020.

At Operation S18.5, the third repair result [symbol] 1010 and the second repair result [symbol] 1020 are combined to determine a total probability distribution mean [symbol] 519 of the missing regions (the first region and the second region) containing the target object content. A specific determination manner may be seen from the description of FIG. 10 and will not be described in detail herein.

At Operation S18.6, \hat{Z}_{T} 516 (the second image adding the first noise) and [symbol] 1020 are processed using the standard sampling method (such as the DDIM) to obtain [symbol] (the fourth repair result) 1030 that both the first region and the second region generate a background. A specific determination manner may be seen from the description of FIG. 12 and will not be described in detail herein.

At Operation S18.7, similarities between [symbol] 519 and [symbol] 810, the second image feature of the target object 424, and the known position image 820 are determined to obtain guidance information 800. In an embodiment, a similarity between a M₁ region (i.e., the second region) of [symbol] 519 and a M₁ region of [symbol] 810 is determined to obtain guidance information 1, a similarity between a M₂ region (i.e., the first region) of [symbol] 519 and the second image feature of the target object 424 is determined to obtain guidance information 2, and a similarity between a background region of [symbol] 519 and a background region of Z₀ 820 is determined to obtain guidance information 3. A specific determination manner may be seen from the description of FIG. 8 and will not be described in detail herein.

At Operation S18.8, the total probability distribution [symbol] 519 is corrected by determining the correction coefficient 1310 through the guidance information 800 to ensure that the M₂ region generates the target object, and the M₁ region recovers the background to obtain target probability distribution [symbol] 1320. A specific correction manner may be seen from the description of FIGS. 14-17 and will not be described in detail herein.

At Operation S18.9, at least one type of first noise is added to the known position image (where a noise addition process is not shown in FIG. 18D), a random noise Z 440 is added to the target probability distribution [symbol] 1320 and spliced with the known position image (i.e., the corresponding third image) after the first noise addition (with the highest degree of noise addition) to obtain \hat{Z}_{T-1} 730, and a next denoising process is performed with reference to \hat{Z}_{T} 516.

At Operation S18.10, the above process is performed repeatedly until the last denoising result encoding \hat{Z}₀ 750 is outputted. The encoding \hat{Z}₀ 750 is converted to a pixel space using a VAE decoder 460 to obtain a final result image 470.

In the image object reposition method provided in the embodiments of the present application, in each iterative denoising process of the first AI network, the repair result of the original region is used as the guidance information 1, content information of the target object is used as the guidance information 2, and the image lacking the original region and the destination region is also added as the guidance information 3 so that the first AI network may recover the realistic and natural background content in the original region and generate the harmonious and natural target object content in the destination region at the same time.

The image object reposition method provided in the embodiments of the present application has a strong generation capability for the case where the original region is lost in a large area or the background is complicated due to the removal of the target object with a large area, and can not only recover the missing regions well, but also generate a harmonious, natural, and realistic image object reposition result.

In an embodiment, if the first AI network adopts the Diffusion module, the image object reposition method provided by the embodiments of the present application does not need two or more Diffusion modules, and only one Diffusion module is needed to ensure that the destination region generates a harmonious and natural target object, and the original area recovers a natural and realistic background. The calculation efficiency of the network model is improved by reducing the calculation amount and calculation parameters.

In practical application, in one or more examples, the first AI network usually includes a normalization module, such as containing a large number of group normalization (GN) modules, i.e., the above-mentioned target object removal processing includes normalization processing. In an embodiment of the present application, an alternative implementation is provided for the normalization processing process of the normalization module, which may specifically include the following operations.

At Operation SC1, input features may be split into a first preset number of first feature groups.

At Operation SC2, the first feature groups may be combined to obtain corresponding second feature groups.

At Operation SC3, normalization processing may be performed on the second feature groups.

These operations may be performed because current group normalization methods require multiple split operations to obtain feature map groups. Then, normalization processing is performed on each group of feature maps. However, split operations may frequently modify a calculation processing process of a graphics processing unit (GPU), reducing the efficiency of GPU parallel computing so that too many split operations will result in a high delay, especially in a mobile device.

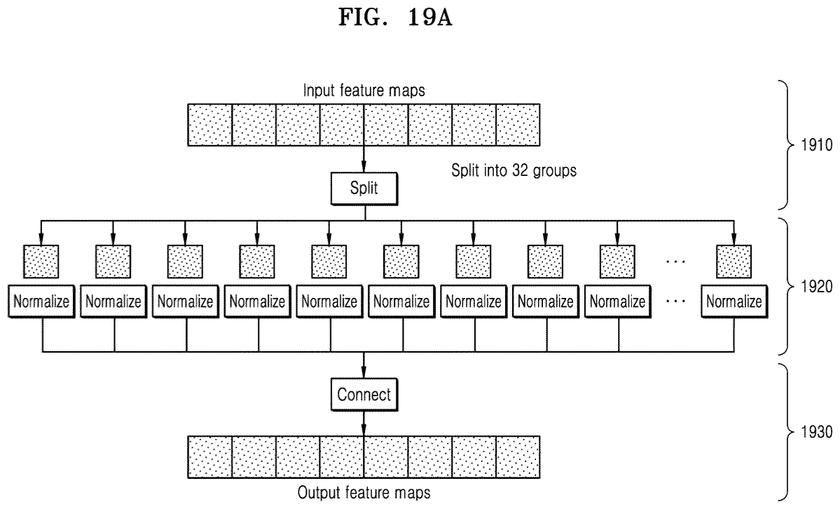

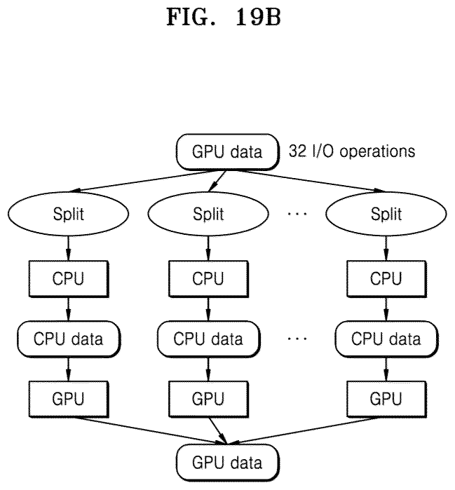

For example, current group normalization methods may split the feature map into N1 groups, such as 32 groups, to obtain 32 feature map groups, and then normalization processing is performed on each feature map group, as shown in FIG. 19A. When the split operation is performed on the feature map, the data will be converted to a CPU. After completion of processing by CPU, the GPU will be inputted. Thus, if there are many split operations, there will be many input/output (I/O) operations between the GPU and the CPU. As shown in FIG. 19B, if N1=32, 32 I/O operations will be generated, resulting in the high delay.

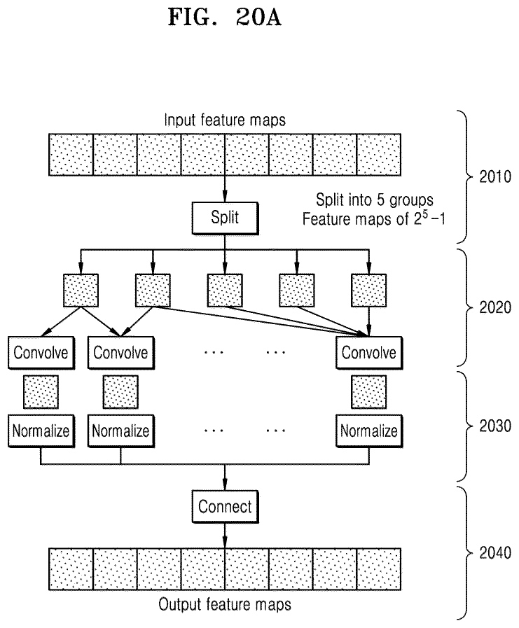

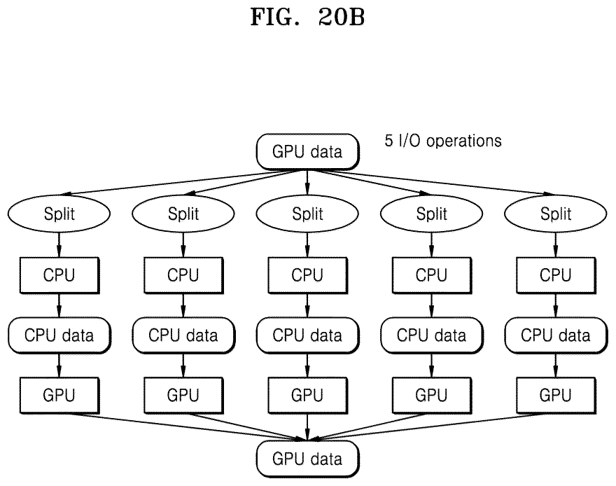

In order to reduce I/O operations, an embodiment of the present application may propose a grouping combination normalization method. In an embodiment, the feature map may be divided into N2 groups, such as 5 groups, i.e., N2 may be smaller than N1, and then N2 feature map groups are combined by arranging and combining to obtain feature maps of 2^{N2}−1 groups. For example, N2=5, feature maps of 31 groups may be obtained, as shown in FIG. 20A. All groups may then be converted to the same channel using a 1*1 convolution, and then normalization processing may be performed on each group of feature maps.

In the normalization method provided in an embodiment of the present application, if N2=5, after 5 I/O operations, the data all enter the GPU, as shown in FIG. 20B. Even if there are some 1*1 convolution calculations, the data is processed on the GPU, which means that a delay time is very short compared with the previous 32 I/O operations, but it is still possible to extract the same stable feature as the original group normalization.

In an embodiment of the present application, the novel sampling method and the grouping combination normalization method may be used in combination. The former mainly solves the problems of image object reposition effect and the calculation efficiency of the network model, and the latter mainly solves the problem of high read-write delay.

In one or more examples, with regard to the overall processing flow of image object reposition shown in FIG. 4, for the output result of each denoising iteration of the Diffusion network, the novel sampling method is used for processing. In an embodiment, the similarity between the first repair result of the original region after this iteration processing and an expected repair result (the expected repair result is the background content rather than the target object content) may be used to determine the guidance information 1, the similarity between the first repair result of the destination region after this iteration processing and a semantic feature of the target object is used to determine the guidance information 2, and in order to ensure that the background is unchanged during the generation process of the image, the similarity between the first repair result of the background region after this iteration processing and the background region of the original image may be used to determine the guidance information 3. Further, the guidance information 1-3 is used to adjust the first repair result of this iteration processing so that the sampling probability of the original region for the background content may become greater, the sampling probability of the destination region for the target object content may become greater, and the sampling probability of the background region for the same background content of the original image may become greater.

In one or more examples, for the normalization module in the Diffusion network, by arranging and combining, only a small number of split operations, such as N2, are required to obtain N2 feature map groups, and feature maps of 2^{N2}−1 groups are obtained by combining so that the same stable feature as the original group normalization operation may be extracted using a small number of split operations.

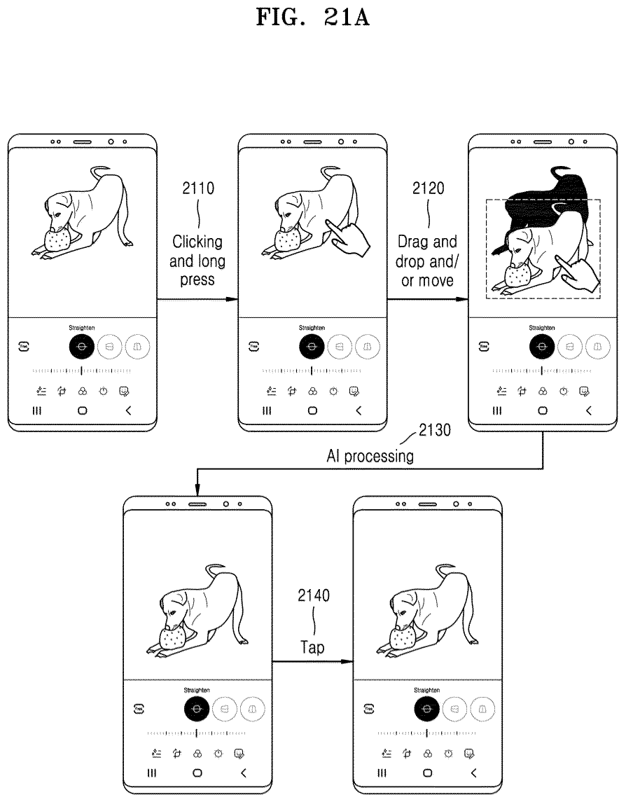

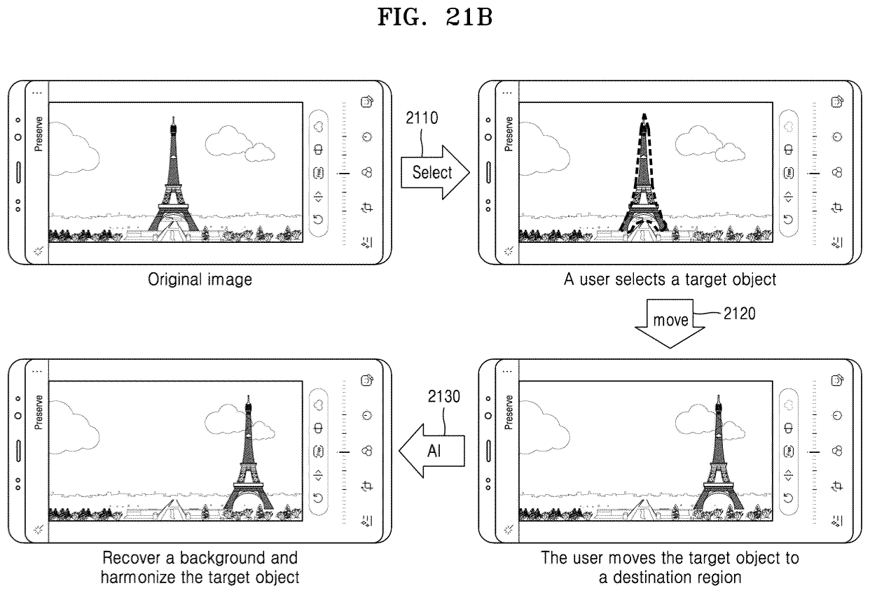

The image object reposition method provided by the embodiments of the present application may be applied to a scene as shown in FIG. 21A or FIG. 21B. In an embodiment, a target object may be selected by clicking and long-pressing in an original image through an application program at 2110. After receiving the long-pressing operation of the user, the selected target object may be highlighted by floating and so on. In an embodiment, the user may drag and drop and/or move the target object to determine a destination region in which to place the target object at 2120. After the user confirms that the dragging and dropping and/or moving is complete (such as pressing a “Done” button, but not limited thereto), the AI may process the missing original region and merge the target object into a new destination region and present the AI processed image at 2130. In an embodiment, the AI may recover a background and harmonize the target object. The user taps again to preserve the new image presented by the AI at 2140.

The image object reposition method provided by the embodiments of the present application has a high-quality image processing result, for example, a very natural effect can be achieved in a shaded part or an image inpainting result.

In addition, it has been verified through a large number of experiments conducted by the inventors of the present application that an operation time of the grouping combination normalization method provided by the embodiments of the present application is significantly improved compared with an operation time of the original group normalization method, and especially, an operation speed at a mobile end is significantly improved.

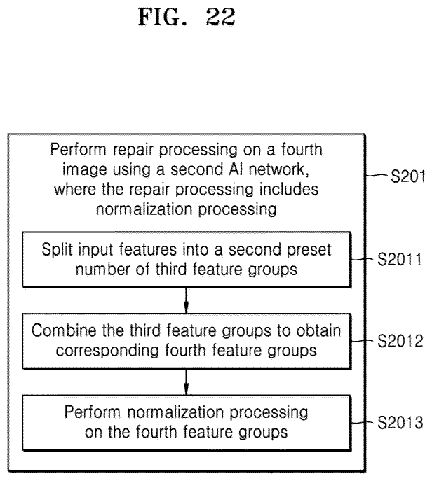

In the embodiments of the present application, there is also provided an method performed by an electronic device, as shown in FIG. 22, including the following operations.

At Operation S201: repair processing may be performed on a fourth image using a second AI network.

The repair processing may include normalization processing, and the normalization processing may include the following operations.

At Operation S2011, input features may be split into a second preset number of third feature groups.

At Operation S2012, the third feature groups may be combined to obtain corresponding fourth feature groups.

At Operation S2013: normalization processing may be performed on the second fourth groups.

In an embodiment of the present application, the fourth image refers to an image for which image object reposition (also understood as a target object to be moved) is to be performed. In one or more examples, the fourth image may be a stored image, for example, an image selected in an album for image object reposition; In one or more examples, the fourth image may be an image to be stored, for example, an image captured in real time by a camera for image object reposition and then stored, and the source and function of the fourth image are not specifically defined in the embodiments of the present application.

For the embodiments of the present application, a type of the target object is not specifically defined. In one or more examples, the target object may refer to, a person, a pet, a plant, a building, an item, etc., but is not limited thereto.

In an embodiment of the present application, performing repair processing on the fourth image using the second AI network includes but is not limited to performing removal processing, image inpainting processing, image outpainting processing, processing of generating an image based on text, image fusion processing, and image style conversion processing. A person skilled in the art may set the type and training manner of the second AI network according to actual situations, and the embodiments of the present application are not limited herein. In an embodiment, an embodiment of the present application may be applied to a scene using any AI algorithm to perform removal processing on a target object in the fourth image and may include but are not limited to the second AI network being a Diffusion network model, a generative adversarial network (GAN) network model, etc. The second AI network includes a normalization module.

Current group normalization methods require multiple split operations to obtain feature map groups. Then, normalization processing is performed on each group of feature maps. In an embodiment, split operations may frequently modify a calculation processing process of a GPU, reducing the efficiency of GPU parallel computing so that too many split operations will result in a high delay, especially in a mobile device.

For example, current group normalization methods may split the feature map into N1 groups in 1910, such as 32 groups, to obtain 32 feature map groups, and then normalization processing is performed on each feature map group in 1920, result of the normalization processing may be connected (e.g. concatenation operation) to obtain output feature maps in 1930, as shown in FIG. 19A. When the split operation is performed on the feature map, the data will be converted to a CPU. After completion of processing by CPU, the GPU will be inputted. Thus, if there are many split operations, there will be many input/output (I/O) operations between the GPU and the CPU. As shown in FIG. 19B, if N1=32, 32 I/O operations will be generated, resulting in the high delay.

In order to reduce I/O operations, an embodiment of the present application propose a grouping combination normalization method. In an embodiment, the feature map may be divided into N2 groups, such as 5 groups, i.e., N2 may be significantly smaller than N1, and then N2 feature map groups are combined by arranging and combining to obtain feature maps of 2^{N2}−1 groups. For example, N2=5, feature maps of 31 groups may be obtained in 2010, as shown in FIG. 20A. All groups may be then be converted to the same channel using a 1*1 convolution in 2020, and then normalization processing is performed on each group of feature maps in 2030, result of the normalization processing may be connected (e.g. concatenation operation) to obtain output feature maps in 2040.

In the normalization method provided in the embodiments of the present application, if N2=5, after 5 I/O operations, the data may all enter the GPU, as shown in FIG. 20B. Even if there are some 1*1 convolution calculations, they are processed on the GPU, which means that a delay time is very short compared with the previous 32 I/O operations, but it is still possible to extract the same stable feature as the original group normalization.

In the normalization method provided in the embodiments of the present application, by arranging and combining, only a small number of split operations, such as N2, are required to obtain N2 feature map groups, and feature maps of 2^{N2}−1 groups are obtained by combining so that the same stable feature as the original group normalization operation may be extracted using a small number of split operations.

The technical solutions provided by the embodiments of the present application may be applied to various electronic devices, including but not limited to mobile terminals, intelligent terminals, such as smart phones, tablet computers, laptop computers, intelligent wearing devices (such as watches and glasses), intelligent speakers, vehicle-mounted terminals, personal digital assistants, portable multimedia players, navigation apparatuses, etc. It will be appreciated by a person skilled in the art that the construction according to the embodiments of the present application can also be applied to fixed types of terminals, such as digital televisions and desktop computers, in addition to elements specifically for mobile purposes.

The technical solutions provided by the embodiments of the present application may also be applied to image object reposition processing in a server, such as an independent physical server, a server cluster or a distributed system composed of multiple physical servers, and a cloud server providing basic cloud computing services, such as a cloud service, a cloud database, cloud computing, a cloud function, cloud storage, a network service, cloud communication, a middleware service, a domain name service, a security service, a content delivery network (CDN), and a big data and AI platform.

Specifically, the technical solutions provided by the embodiments of the present application may be applied to image AI editing applications on various electronic devices, improve the performance of image object reposition, improve the calculation efficiency of the electronic device, and reduce the read-write delay.

The embodiments of the present disclosure further comprise an electronic device comprising a processor and, optionally, a transceiver and/or memory coupled to the processor configured to perform the operations of the method provided in any of the optional embodiments of the present disclosure.

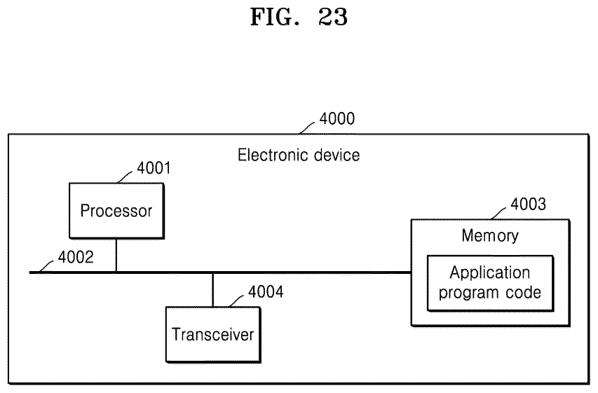

FIG. 23 shows a schematic structure diagram of an electronic device to which one or more embodiments of the present disclosure is applied. As shown in FIG. 23, the electronic device 4000 shown in FIG. 23 may include a processor 4001 and a memory 4003. The processor 4001 is connected to the memory 4003, for example, through a bus 4002. Optionally, the electronic device 4000 may further include a transceiver 4004, and the transceiver 4004 may be used for data interaction between the electronic device and other electronic devices, such as data transmission and/or data reception. It should be noted that, in practical applications, the transceiver 4004 is not limited to one, and the structure of the electronic device 4000 does not constitute a limitation to the embodiments of the present disclosure. Optionally, the electronic device may be a first network node, a second network node or a third network node.

The processor 4001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components, or any combination thereof. It may implement or execute the various exemplary logical blocks, modules and circuits described in connection with this disclosure. The processor 4001 can also be a combination that implements computing functions, such as a combination of one or more microprocessors, a combination of a DSP and a microprocessor, and the like.

The bus 4002 may include a path to transfer information between the components described above. The bus 4002 may be a PCI (Peripheral Component Interconnect) bus or an EISA (Extended Industry Standard Architecture) bus or the like. The bus 4002 can be divided into an address bus, a data bus, a control bus, and the like. For ease of representation, only one thick line is shown in FIG. 23, but it does not mean that there is only one bus or one type of bus.

The memory 4003 may be a ROM (Read Only Memory) or other types of static storage devices that can store static information and instructions, a RAM (Random Access Memory) or other types of dynamic storage devices that can store information and instructions, and can also be EEPROM (Electrically Erasable Programmable Read Only Memory), CD-ROM (Compact Disc Read Only Memory) or other optical disk storage, compact disk storage (including compressed compact disc, laser disc, compact disc, digital versatile disc, blue-ray disc, etc.), magnetic disk storage media, other magnetic storage devices, or any other medium capable of carrying or storing computer programs and capable of being read by a computer, without limitation.

The memory 4003 is used for storing computer programs for executing the embodiments of the present disclosure, and the execution is controlled by the processor 4001. The processor 2401 is configured to execute the computer programs stored in the memory 4003 to implement the operations shown in the foregoing method embodiments.

Embodiments of the present disclosure provide a computer-readable storage medium having a computer program stored on the computer-readable storage medium, the computer program, when executed by a processor, implements the operations and corresponding contents of the foregoing method embodiments.

Embodiments of the present disclosure also provide a computer program product including a computer program, the computer program when executed by a processor realizing the operations and corresponding contents of the preceding method embodiments.

The terms “first”, “second”, “third”, “fourth”, “1”, “2”, etc. (if present) in the specification and claims of this disclosure and the accompanying drawings above are used to distinguish similar objects and need not be used to describe a particular order or sequence. It should be understood that the data so used is interchangeable where appropriate so that embodiments of the present disclosure described herein can be implemented in an order other than that illustrated or described in the text.

It should be understood that while the flow diagrams of embodiments of the present disclosure indicate the individual operational operations by arrows, the order in which these operations are performed is not limited to the order indicated by the arrows. Unless explicitly stated herein, in some implementation scenarios of embodiments of the present disclosure, the implementation operations in the respective flowcharts may be performed in other orders as desired. In addition, some, or all of the operations in each flowchart may include multiple sub-operations or multiple phases based on the actual implementation scenario. Some or all of these sub-operations or stages can be executed at the same moment, and each of these sub-operations or stages can also be executed at different moments separately. The order of execution of these sub-operations or stages can be flexibly configured according to requirements in different scenarios of execution time, and the embodiments of the present disclosure are not limited thereto.

According to an embodiment, a method performed by an electronic device may include acquiring a first image, a target object to be moved in the first image, and a first region after the target object is moved. The method may include performing target object removal processing on the first image using a first artificial intelligence (AI) network based on guidance information related to the first region and/or a second region, wherein the second region is a region of the target object in the first image.

According to an embodiment, the performing the target object removal processing on the first image using the first AI network based on the guidance information related to at least one of the first region and a second region may include obtaining a first repair result of performing the target object removal processing on the first image using the first AI network. The method may include performing correction processing on the first repair result based on the guidance information related to the first region and/or the second region to obtain a removal processing result of performing the target object removal processing on the first image. The method may include performing correction processing on the first repair result based on the guidance information related to the first region and/or the second region. The method may include obtaining a removal processing result of performing the target object removal processing on the first image.

According to an embodiment, the method may include, prior to performing the correction processing, the guidance information related to the first region and/or the second region based on the first repair result.

According to an embodiment, the method may include the guidance information related to the first region and/or the second region based on the first repair result.

According to an embodiment, the guidance information may include a first similarity value indicating a similarity between content of the second region in the first repair result and background content of the first image. The guidance information may include a similarity value indicating a similarity between content of the second region in the first repair result and the second region in a second repair result. The second repair result may be a repair result in which both the first region and the second region in the first repair result generate background content. The guidance information may include a second similarity value indicating a similarity between content of the target object and content of the first region in the first repair result. The guidance information may include a similarity between content of the target object and content of the first region in the first repair result. The guidance information may include a third similarity value indicating a similarity between background content of the first repair result and the background content of the first image. The guidance information may include a similarity between background content of the first repair result and the background content of the first image.

According to an aspect of the disclosure, the determining the guidance information related to the first region and/or the second region based on the first repair result may include determining first guidance information based on the second region in the first repair result and the second region in the second repair result. The second repair result may be a repair result in which both the first region and the second region in the first repair result generate background content. The determining the guidance information related to the first region and/or the second region based on the first repair result may include determining second guidance information based on the target object and the first region in the first repair result.

According to an embodiment, the determining the second guidance information based on the target object and the first region in the first repair result may include extracting relevance information between different spatial positions of a first image feature of the target object to obtain a second image feature of the target object. The determining the second guidance information based on the target object and the first region in the first repair result may include determining the second guidance information based on the second image feature and the first region in the first repair result.

According to an embodiment, the determining first guidance information based on the second region in the first repair result and the second region in a second repair result may include determining the first guidance information based on the first similarity value indicating a similarity between the content of the second region in the first repair result and the second region in the second repair result. The determining second guidance information based on the target object and the first region in the first repair result may include determining the second guidance information based on a second similarity value indicating a similarity between the content of the target object and the content of the first region in the first repair result.

According to an embodiment, the determining first guidance information based on the second region in the first repair result and the second region in the second repair result may include determining the first guidance information based on the similarity between the second region in the first repair result and the second region in the second repair result. The determining second guidance information based on the target object and the first region in the first repair result may include determining the second guidance information based on a similarity between the target object and the first region in the first repair result.

According to an embodiment, the determining the guidance information related to the first region and/or the second region based on the first repair result further may include determining third guidance information based on a second image and a region other than the first region and the second region in the first repair result, the second image corresponding to the first image after the first region and the second region are removed from the first image.

According to an embodiment, the determining the guidance information related to the first region and/or the second region based on the first repair result further may include determining third guidance information based on the third similarity value indicating the similarity between the background content of the first repair result and the background content of the first image.

According to an aspect of the disclosure, the determining third guidance information based on the second image and the region other than the first region and the second region in the first repair result may include determining the third guidance information based on a third similarity value indicating a similarity between the second image and the region other than the first region and the second region in the first repair result.

According to an embodiment, the determining third guidance information based on the third similarity value indicating the similarity between the background content of the first repair result and the background content of the first image may include determining the third guidance information based on a third similarity value indicating a similarity between the second image and the region other than the first region and the second region in the first repair result.

According to an embodiment, the obtaining the first repair result of performing the target object removal processing on the first image using the first AI network may include obtaining a third repair result in which both the first region and the second region generate content of the target object using the first AI network based on a first image feature of the target object and a second image. The second image corresponding to the first image after the first region and the second region may be removed from the first image. The obtaining the first repair result of performing the target object removal processing on the first image using the first AI network may include obtaining the second repair result in which both the first region and the second region generate the background content using the first AI network based on a preset feature and the second image; and obtaining the first repair result based on the third repair result and the second repair result.

According to an embodiment, the obtaining the first repair result based on the third repair result and the second repair result may include fusing the third repair result and the second repair result. The obtaining the first repair result based on the third repair result and the second repair result may include performing sampling processing on a fusion result and the second image to obtain the first repair result.

According to an embodiment, the determining first guidance information based on the second region in the first repair result and a second region in a second repair result may include performing sampling processing on the second repair result and the second image to obtain a fourth repair result. The determining first guidance information based on the second region in the first repair result and a second region in a second repair result may include determining the first guidance information based on the second region in the first repair result and a second region in the fourth repair result.

According to an embodiment, the performing correction processing on the first repair result based on the guidance information related at the first region and/or the second region may include determining a correction coefficient corresponding to the first repair result based on the guidance information related at the first region and/or the second region. The performing correction processing on the first repair result based on the guidance information related at the first region and/or the second region may include performing the correction processing on the first repair result based on the correction coefficient.

According to an embodiment, the determining the correction coefficient corresponding to the first repair result based on the guidance information related to the first region and/or the second region may include performing a derivative operation for the first repair result on the guidance information related to the first region and/or the second region to obtain the correction coefficient. The determining the correction coefficient corresponding to the first repair result based on the guidance information related to the first region and/or the second region may include performing a derivative operation for the first repair result on the guidance information related to the first region and/or the second region. The determining the correction coefficient corresponding to the first repair result based on the guidance information related to the first region and/or the second region may include obtaining the correction coefficient.

According to an embodiment, the performing the derivative operation for the first repair result on the guidance information related to the first region and/or the second region to obtain the correction coefficient may include determining a gradient of a result of the derivation operation. The performing the derivative operation for the first repair result on the guidance information related to the first region and/or the second region to obtain the correction coefficient may include determining a direction and/or a degree of modification of the first repair result as the correction coefficient based on the gradient.

According to an embodiment, the performing target object removal processing on the first image using a first AI network may include performing the target object removal processing using the first AI network based on the target object and the second image to obtain a first removal processing result, the second image corresponding to the first image after the first region and the second region are removed from the first image. The performing target object removal processing on the first image using a first AI network may include repeating the operation of performing the target object removal processing using the first AI network based on the target object and a last removal processing result until a set condition is reached to obtain the removal processing result of performing the target object removal processing on the first image. The performing target object removal processing on the first image using a first AI network may include repeating the operation of performing the target object removal processing using the first AI network based on the target object. The performing target object removal processing on the first image using a first AI network may include obtaining a removal processing result based on a determination that a set condition is reached.

According to an embodiment, the target object removal processing comprises normalization processing, and the normalization processing may include splitting a plurality of input features into a first preset number of first feature groups. The target object removal processing comprises normalization processing, and the normalization processing may include combining the first feature groups to obtain corresponding second feature groups; and performing normalization processing on the second feature groups.

According to an embodiment, the performing normalization processing on the second feature groups may include performing convolution processing on the second feature groups. The performing normalization processing on the second feature groups may include performing normalization processing on second feature groups after the convolution processing. The performing normalization processing on the second feature groups may include fusing second feature groups after the normalization processing.

According to an embodiment, the first AI network may be a Diffusion network.

According to an embodiment, a method performed by an electronic device may include performing repair processing on a first image using a first artificial intelligence (AI) network. The repair processing comprises normalization processing that may include splitting a plurality of input features into a first preset number of first feature groups. The repair processing may include normalization processing that may include combining the first feature groups to obtain corresponding second feature groups. The method may include performing normalization processing on the second feature groups.

According to an embodiment, a method performed by an electronic device may include performing repair processing on a fourth image using a first artificial intelligence (AI) network. The repair processing comprises normalization processing that may include splitting a plurality of input features into a second preset number of first feature groups. The repair processing may include normalization processing that may include combining the second feature groups to obtain corresponding third feature groups. The method may include performing normalization processing on the fourth feature groups.

According to an embodiment, the performing normalization processing on the second feature groups may include performing convolution processing on the second feature groups. The performing normalization processing on the second feature groups may include performing normalization processing on second feature groups after the convolution processing. The performing normalization processing on the second feature groups may include fusing the second feature groups after the normalization processing.

According to an embodiment, the performing normalization processing on the second feature groups may include performing convolution processing on the fourth feature groups. The performing normalization processing on the fourth feature groups may include performing normalization processing on second feature groups after the convolution processing. The performing normalization processing on the fourth feature groups may include fusing the fourth feature groups after the normalization processing.

According to an embodiment, an electronic device may include a memory storing instructions and a processor configured to retrieve the instructions that cause the processor to acquire a first image comprising at least a first region and a second region and a target object to be moved in the first image from the second region to the first region. The processor may be configured to retrieve the instructions that cause the processor to perform target object removal processing on the first image using a first artificial intelligence (AI) network based on guidance information related to the first region and/or a second region, wherein the second region is a region of the target object in the first image in which the target object is located prior to the removal processing.

According to an embodiment, a non-transitory computer-readable storage medium having instructions stored therein, which when executed by a processor cause the processor to acquire a first image including at least a first region and a second region and a target object to be moved in the first image from the second region to the first region. The non-transitory computer-readable storage medium having instructions stored therein, which when executed by a processor cause the processor to perform target object removal processing on the first image using a first artificial intelligence (AI) network based on guidance information related to the first region and/or a second region, wherein the second region is a region of the target object in the first image in which the target object is located prior to the removal processing.

According to an embodiment, a computer program product may include a computer program, the computer program, when executed by a processor, causes the processor to acquire a first image comprising at least a first region and a second region and a target object to be moved in the first image from the second region to the first region. The computer program, when executed by a processor, causes the processor to perform target object removal processing on the first image using a first artificial intelligence (AI) network based on guidance information related to the first region and/or a second region, wherein the second region is a region of the target object in the first image in which the target object is located prior to the removal processing.

The above text and accompanying drawings are provided as examples only to assist the reader in understanding the present disclosure. They are not intended and should not be construed as limiting the scope of the present disclosure in any way. Although certain embodiments and examples have been provided, based on what is disclosed herein, it will be apparent to those skilled in the art that the embodiments and examples shown may be altered without departing from the scope of the present disclosure. Employing other similar means of implementation based on the technical ideas of the present disclosure also fall within the scope of protection of embodiments of the present disclosure.

What is claimed is:

1. A method performed by an electronic device, comprising:
acquiring a first image comprising at least a first region and a second region a target object to be moved in the first image from the second region to the first region, and the first region after the target object is moved; and
performing target object removal processing on the first image using a first artificial intelligence (AI) network based on guidance information related to at least one of the first region and the second region,
wherein the second region is a region of the target object in the first image in which the target object is located prior to the removal processing.

2. The method according to claim 1, wherein the performing the target object removal processing on the first image using the first AI network based on the guidance information related to at least one of the first region and the second region comprises:
obtaining a first repair result of performing the target object removal processing on the first image using the first AI network;
performing correction processing on the first repair result based on the guidance information related to at least one of the first region and the second region to obtain a removal processing result of performing the target object removal processing on the first image.

3. The method according to claim 2, further comprising:
determining, prior to performing the correction processing, the guidance information related to at least one of the first region and the second region based on the first repair result.

4. The method according to claim 2, wherein the guidance information comprises at least one of:
a first similarity value indicating a similarity between content of the second region in the first repair result and the second region in a second repair result, wherein the second repair result is a repair result in which both the first region and the second region in the first repair result generate background content;
a second similarity value indicating a similarity between content of the target object and content of the first region in the first repair result; and
a third similarity value indicating a similarity between background content of the first repair result and the background content of the first image.

5. The method according to claim 3, wherein the determining the guidance information related to at least one of the first region and the second region based on the first repair result comprises:
determining first guidance information based on the second region in the first repair result and the second region in the second repair result, wherein the second repair result is a repair result in which both the first region and the second region in the first repair result generate background content; and
determining second guidance information based on the target object and the first region in the first repair result.

6. The method according to claim 5, wherein the determining the second guidance information based on the target object and the first region in the first repair result comprises:
extracting relevance information between different spatial positions of a first image feature of the target object to obtain a second image feature of the target object; and
determining the second guidance information based on the second image feature and the first region in the first repair result.

7. The method according to claim 5, wherein the determining the first guidance information based on the second region in the first repair result and the second region in the second repair result comprises:
determining the first guidance information based on the first similarity value indicating the similarity between the content of the second region in the first repair result and the second region in the second repair result; and
the determining second guidance information based on the target object and the first region in the first repair result comprises:
determining the second guidance information based on the second similarity value indicating the similarity between the content of the target object and the content of the first region in the first repair result.

8. The method according to claim 5, wherein the determining the guidance information related to at least one of the first region and the second region based on the first repair result further comprises:
determining third guidance information based on the third similarity value indicating the similarity between the background content of the first repair result and the background content of the first image.

9. The method according to claim 5, wherein the obtaining the first repair result of performing the target object removal processing on the first image using the first AI network comprises:
obtaining a third repair result in which both the first region and the second region generate content of the target object using the first AI network based on a first image feature of the target object and a second image, the second image corresponding to the first image after the first region and the second region are removed from the first image;
obtaining the second repair result in which both the first region and the second region generate the background content using the first AI network based on a preset feature and the second image; and
obtaining the first repair result based on the third repair result and the second repair result.

10. The method according to claim 9, wherein the obtaining the first repair result based on the third repair result and the second repair result comprises:
fusing the third repair result and the second repair result; and
performing sampling processing on a fusion result and the second image to obtain the first repair result.

11. The method according to claim 9, wherein the determining the first guidance information based on the second region in the first repair result and the second region in the second repair result comprises:
performing sampling processing on the second repair result and the second image to obtain a fourth repair result; and
determining the first guidance information based on the second region in the first repair result and a second region in the fourth repair result.

12. The method according to claim 2, wherein the performing the correction processing on the first repair result based on the guidance information related to at least one of the first region and the second region comprises:
determining a correction coefficient corresponding to the first repair result based on the guidance information related to at least one of the first region and the second region; and
performing the correction processing on the first repair result based on the correction coefficient.

13. The method according to claim 12, wherein the determining the correction coefficient corresponding to the first repair result based on the guidance information related to at least one of the first region and the second region comprises:
performing a derivative operation for the first repair result on the guidance information related to at least one of the first region and the second region to obtain the correction coefficient.

14. The method according to claim 13, wherein the performing the derivative operation for the first repair result on the guidance information related to at least one of the first region and the second region to obtain the correction coefficient comprises:
determining a gradient of a result of the derivation operation; and
determining at least one of a direction and a degree of modification of the first repair result as the correction coefficient based on the gradient.

15. The method according to 1, wherein the performing the target object removal processing on the first image using the first AI network comprises:
performing the target object removal processing using the first AI network based on the target object and the second image to obtain a first removal processing result, the second image corresponding to the first image after the first region and the second region are removed from the first image; and
repeating the operation of performing the target object removal processing using the first AI network based on the target object to obtain a removal processing result based on a determination that a set condition is reached.

16. The method according to claim 1, wherein the target object removal processing comprises normalization processing, and the normalization processing comprises:
splitting a plurality of input features into a first preset number of first feature groups;
combining the first feature groups to obtain corresponding second feature groups; and
performing normalization processing on the second feature groups.

17. The method according to claim 16, wherein the performing normalization processing on the second feature groups comprises:
performing convolution processing on the second feature groups;
performing normalization processing on second feature groups after the convolution processing; and
fusing second feature groups after the normalization processing.

18. The method according to claim 1, wherein the first AI network is a Diffusion network.

19. An electronic device, comprising:
a memory storing instructions; and
a processor configured to retrieve the instructions that cause the processor to:
acquire a first image comprising at least a first region and a second region and a target object to be moved in the first image from the second region to the first region; and
perform target object removal processing on the first image using a first artificial intelligence (AI) network based on guidance information related to at least one of the first region and the second region,
wherein the second region is a region of the target object in the first image in which the target object is located prior to the removal processing.

20. A non-transitory computer-readable storage medium having instructions stored therein, which when executed by a processor cause the processor to execute:
acquire a first image comprising at least a first region and a second region and a target object to be moved in the first image from the second region to the first region; and
perform target object removal processing on the first image using a first artificial intelligence (AI) network based on guidance information related to at least one of the first region and the second region,
wherein the second region is a region of the target object in the first image in which the target object is located prior to the removal processing.
